(19) United States
(12) Patent Application Publication
(10) Pub. No.: US 2025/0081907 A1
(43) Pub. Date: Mar. 13, 2025

(54) Aero Rooter

(71) Applicant: Chandana Vindika Kumara Lokunarangodage, Brampton (CA)

(72) Inventor: Chandana Vindika Kumara Lokunarangodage, Brampton (CA)

(21) Appl. No.: 18/464,206

(22) Filed: Sep. 9, 2023

(51) Int. Cl. A01G 29/00; A01G 9/02; A01G 27/02

(52) U.S. Cl. CPC A01G 29/00; A01G 9/02; A01G 27/02

(57) ABSTRACT

A fertilizer conveyance assembly comprising at least one perforated air cushion, characterized by a plurality of air channels, and a plurality of nutrient bricks, configured to air prune plant roots, and control-release an assortment of fertilizer chemical compounds, designed to enhance the growth of horticultural plants. Thus, object of the aero rooter is to provide an efficient plant fertilizer conveyance apparatus with multi-functional effects such as reduced circular roots, extended oxygen supply for the growth of root system through substrate aeration, excess water retention, micro and secondary fertilizer control-release with reduced chemical interactions throughout the life cycle without secondary applications, and uninterrupted nutrient supply from the gravity-fed water collected within the lower perforated air cushion. Further, aero rooter provides all required micro and secondary required fertilizer chemicals on a single applicator, which is highly cost-effective and less labour-intensive solution for optimizing plant growth in a variety of horticultural contexts.

### CROSS-REFERENCE TO RELATED APPLICATIONS

Not Applicable.

### STATEMENT REGARDING FEDERALLY SPONSORED RESEARCH OR DEVELOPMENT

Not Applicable.

### Field of the Invention

The present invention generally relates to the field of horticulture, and more particularly, the present disclosure relates to a hybrid plant fertilizer conveyance assembly.

### BACKGROUND OF THE INVENTION

Plant growth is highly influenced by the development of a healthy root system, which in return provides faster growth and increases productivity by absorbing water-soluble nutrients and oxygen, thus providing an uninterrupted supply of major nutrients from the extended root system. Plant root air pruning is a proven technique used in horticulture to promote the healthy growth of plants using applications such as fabric pots, root pruning containers, and air pruning trays that allow air to circulate around the plant roots, which stimulates the growth of new roots due to dehydration of the root tip that prevents the apical dominance. Further, root pruning also minimizes the circular, tangled, or constricted root growth through exposure of roots to the air that promotes branching out of the root in search of water and nutrients, which leads to a healthier root growth and in turn leads to a healthier plant.

Nonetheless, Barney K. Huang introduced a self-watering air-producing plant tray system. U.S. Pat. No. 5,179,800 (Jan. 19, 1993), and later again an air-pruning tray/container matrix, U. S. Pat. U.S. Pat. No. 7,168,375 B2 (Jan. 30, 2007), and Aart Van Wingerden presented an ornamental plant tray with improved air pruning, U.S. Des. Pat. 381,933 (, Aug. 5, 1997), who have introduced improved devices for root air pruning to eliminate the apical dominance and the circular root growth wherein plants are intended to be transplanted.

Preferably, the fabric pots are made from breathable fabrics that allow air to circulate around the plant roots, while root pruning containers are designed with slots or holes in the sides that allow air to enter, circulate, and penetrate through the plant roots. Further, air pruning trays may be similar to root pruning containers, which have a tray at the bottom that catches excess water and allows air to circulate through the roots. While plant root air pruning is beneficial, the equipment and methods used can be expensive or may be difficult to use, whereas the use of containers such as fabric pots may be difficult to fill or require more frequent watering than traditional containers. Root pruning containers and air pruning trays can be heavy and difficult to move, which can make them impractical for gardeners and farmers. Nevertheless, humid environments can lead to fungal growth and root rot.

Further, there are various references available for improved plant pots such as U.S. Pat. Nos. 4,442,628, 4,497,132, and 4,939,865 (Carl E. Whitcomb, Stillwater, Apr. 17, 1984, Feb. 5, 1985, and Jul. 10, 1990) that discuss the improvements in air pruning of roots, U. S. Pat. U.S. Pat. No. 7,210,266 B2 (James H Henry, Elona T Henry, May 1, 2005), and further improved in the later developments such as U. S. Pub. US2009/01994.71 A1 (Single et al., Aug. 13, 2009) improving the reduction of circular roots, which use to have disadvantages like water spillover and chemical/nutrient leachate from the substrate to the external environment.

Nonetheless, U.S. Pat. No. 4,716,680 (Whitcomb et al., Jan. 5, 1988), U. S. Pub. US2014/0173982 A1 (KAKU LU, Jun. 26, 2014) have introduced improved mouldable pot assemblies for the elimination of circular root growth wherein plants are intended to be transplanted. In addition, international patent (WPC) No. WO2017018873A1 (Kim Fui NG, 2016) introduced a slow-release fertilizer device, but there are very few prior arts on integrated developments for the references.

Root interactions through chemical signaling have been demonstrated to regulate root growth and development, mineral nutrition, and plant-microbe interactions, as well as plant defense against pests and diseases. Hence, roots possess the ability to eliminate other roots, which enables them to regulate the uptake of harmful chemicals and restrict bacterial growth, thereby creating microenvironments of nutrients, and managing the absorption process that is crucial for protecting plant growth.

Further preferably, fertilizers play an essential role in the growth and development of plants as they are the primary source of nutrients that plants require to survive, grow, and produce high yields, which involves different types of fertilizers, including macro and micro category fertilizers. The macro fertilizers category includes three (03) major plant nutrients (N, P. K) required in larger quantities regularly, and three (03) secondary nutrients that are required in moderate quantities, whereas the micro category includes plant nutrients that are required in micro quantities. Micro and secondary fertilizers are essential to plant nutrients that are required in small quantities, but play a significant role in promoting plant growth and development, whereas micro fertilizers provide essential trace elements such as zinc, copper, boron, manganese, chlorine, iron, nickel, and cobalt. On the other hand, secondary fertilizers provide essential nutrients such as calcium, magnesium, and sulfur that are required in moderate amounts for plant growth and development. Thus, macro and micro fertilizers are equally important in promoting plant growth and ensuring healthy plant development. Hence, plant nutrients play a crucial role in maintaining soil fertility, and improving plant growth and yield, while promoting the overall growth of healthy plants by improving the plant resistance to pests and diseases, and enhancing plant quality and yield.

However, current fertilizer delivery systems are more specialized and developed targeting large-scale operations with specific plant requirements for commercial or industrial applications, whereas small-scale farming operations will only have generic supplements in the market, which are mostly associated with problems. Nevertheless, field application methods such as broadcasting have the potential to receive too much or too little fertilizer, which can be more susceptible to lose due to leaching, volatilization, and runoff that also may lead to uneven plant growth and reduced yields. The side dressing may be labour-intensive as precision applications are required otherwise, the fertilizer may not reach the roots of the plant, or if applied close to the stems that can burn the roots or plant tissues causing damage, which can reduce the effectiveness of the application. Foliar spraying can be an effective method for providing nutrients to the plant, which can also be less efficient than other methods since only a small portion of the applied fertilizer is actually absorbed by the plant as foliar spraying can be more susceptible to losses due to wind, rain, evaporation, and runoff. Thus, there is a requirement for multifunctional devices that can provide specialty functions such as root air pruning, fertilizer delivery, substrate aeration, water retention, etc. at a lower cost for the fast-growing indoor agricultural industry, which requires more efficient solutions for ever-increasing demand due to population growth and resource scarcity as well as low productivity in farmlands.

### BRIEF SUMMARY OF THE INVENTION

The object of the present invention is to provide an efficient plant fertilizer conveyance device with an added function for root air pruning, termed as an acro rooter 100 to use in indoor or outdoor horticultural plant pots that are grown for commercial, or ornamental purposes. The acro rooter 100 comprised of an upper perforated air cushion 110, a plurality of nutrient bricks 120 with different plant micro or secondary fertilizer varieties attached by any appropriate means, and a lower perforated air cushion 130, for the delivery of balanced micro or secondary fertilizer to the plant while increasing the partial root growth through disruption of the apical dominance. Plants require such nutrients in smaller quantities based on the concentration of the plant tissues and cells, whereas if a plant does not receive sufficient quantities of micro and secondary nutrients, it can lead to stunted growth, reduced yield, and poor produce quality. On the other hand, if provided in excess quantities of micro or secondary nutrients more than required, that can cause negative impacts such as toxicity on the plant growth and development. For example, excess micronutrients like copper, manganese, and zinc can lead to toxicity in plants, causing damage to the leaves, stems, and roots, whereas excess calcium can lead to poor uptake of other nutrients like potassium and magnesium, while excess sulfur can cause acidification of the soil and damage to the plant roots. Thus, it is very important to provide horticultural plants with a balanced assortment of all essential micro and secondary nutrients with only the necessary amounts available to ensure healthy growth and optimal yield.

Preferably, the acro rooter 100 provides sufficient air pruning, oxygen for the growth of the root system, excess water retention, balanced micro and secondary fertilizer release throughout the life cycle, and uninterrupted nutrient supply from the gravity-fed water collected within the lower perforated air cushion 130 for growing horticultural plants according to the present invention. Further, the gravity-fed water seeped through the substrate and the upper perforated air cushion 110 may self-acrate and also collect the micro and secondary fertilizer released from the slowly releasing nutrient brick 120, or the aero rooter 100 itself, before being collected back and reused in the lower perforated air cushion 130 to improve multi-functional effects. Further preferably, the aero rooter 100 has several added advantages such as a simple inexpensive light weight design with lesser complications, a single application product with reduced labour costs that require no after care or secondary applications, and increased productivity in overall fertilizer application and use.

Another object of the present invention is to provide all the micro and secondary required fertilizer chemical compounds on a single applicator while reducing the interreactions of water-soluble chemical compounds used to provide specific cations or anions to the medium for absorption through the plant roots. Nonetheless, if large quantities of such chemicals are available in the water-based solution at a given time, there may occur several possible chemical interreaction types such as hydrolysis, oxidation-reduction, precipitation, and acid-base reactions, which may reduce, or increase the availability of such chemical compounds generating unhealthy conditions for plant growth, whereas aero rooter 100 provides a control-release mechanism for such fertilizer delivery and availability, curtailing the quick release and ensuring lower concentrations in the substrate, or absorption media.

Consistent with the provided embodiments of the present invention, the aero rooter 100 comprised of the upper perforated air cushion 110 characterized by a top surface 210, a plurality of apertures 220 for the porosity of the surface, at least one slot opening 230 with a larger diameter configured in the middle area of both upper and lower perforated air cushions 110/130 penetrating through the embodiment to receive a transplant, and a plurality of slot openings 240 for the reception of nutrient bricks 120. In a further preferred embodiment, the upper perforated air cushion 110 may characterize by a wing 310 with an under surface 320, which may be an outward extension of the top surface 210 to create an air trap connecting all air pockets to the external air movement through cracks between the substrate and the sidewall of a plant pot.

Preferably, the upper perforated air cushion 110 further comprised of a bottom surface 330, with the plurality of apertures 220 for the porosity of the bottom of the upper perforated air cushion 110, and the slot opening 230 that may cut through the whole embodiment connecting the over and under substrate layers for the improved plant growth. In further preferred embodiments, the internal structure of the upper perforated air cushion 110 is characterized by an internal surface 410, the plurality of apertures 220 for the porosity of the surface, the slot opening 230, and a plurality of protrusions 420, while configuring a plurality of air channels 430 sandwiched in between top surface 210 and bottom surface 330 horizontally, where the sidewalls created by the protrusion 420 on the internal surface 410 may form the upper perforated air cushion 110 that traps air inside the air channels 430 for air pruning of roots to minimize or prevent the apical dominance, which further improves the partial root growth. Further, the protrusion 420 may dissect due to the apertures 220 configured vertically, which opens through both the top and bottom surface 210/330 for roots to penetrate through the embodiment for the air pruning of roots to prevent apical dominance and to improve oxygen supply.

In further preferred embodiments, the lower perforated air cushion 130 may configure almost similar in configuration to the upper perforated air cushion 110, which also comprised of a top surface 510 similar to the top surface 210, a bottom surface 610 similar to the bottom surface 330, an under surface 620 and an internal surface 630 similar to the internal surface 410, configured to form the protrusion 420 that configure vertical barrier walls to form the air channels 430 inside the lower perforated air cushion 130 that traps atmospheric air inside the air channels 430.

Preferably, the difference between the upper perforated air cushion 110 and the lower perforated air cushion 130 may be very minimal, whereas the lower perforated air cushion 130 does not have an extension creating the wing 310 of the upper perforated air cushion 110 to create an air pocket between the ends of the air channels 430 and the plant pot wall, which help the lower perforated air cushion 130 to reach the bottom of the pot, or as lowest as possible in any given shape of a plant pot and the compatible lower perforated air cushion 130.

In addition or alternatively, the aero rooter 100 may configured with the lower perforated air cushion 130 taller than the upper perforated air cushion 110, in order to provide an extended empty space inside a plant pot at the bottom, which may create a temporary shallow water reservoir at the bottom of the pot periodically that provides uninterrupted water supply to the plant, where leached fertilizers or any other additives may have extended time period for absorption through the root system. Further, the end user must keep his pot bottom seamless by skipping the drilling of the drainage apertures at the pot bottom, where he should make an alternative aperture, or two in the side wall slightly below the top surface 510 of the lower perforated air cushion 130 for excessive water to overflow, provide an inlet for ambient air, and wash the substrate as well as to remove excess gases and salts accumulated as necessary. Preferably, the slot opening 230 characterized in both the upper perforated air cushion 110, and the lower perforated air cushion 130, may configure to receive at least one transplant and create a solid substrate column from the top of the substrate to the bottom that can absorb water through capillary action when the top layers of the substrate are evaporated, or absorbed by the plant roots, which also provides an opportunity for the roots to reach the bottom directly for the absorption of water according to the invention.

In a further preferred embodiment, the nutrient brick 120 comprised of a hollow core 1310, a plurality of apertures 1320 spread around the hollow core 1310, and a barrier film 1330 to cover up the nutrient brick 120 for the control-release of fertilizer variety embedded within the hollow core 1310 of the nutrient brick 120, which may control-release the specific fertilizer variety attached by any appropriate means to the hollow core 1310 of the nutrient brick 120, during a 3-4 month growing season, or after a field planting with perineal plants. Further, the shape of the nutrient brick 120 may configure to characterize by any convenient shape, or design without limitations to the shape, with at least one macro or micro plant fertilizer variety embedded, or spayed on the nutrient brick 120 with an extended surface area for delivery, which may compatible with manufacturing technologies currently available in the market, or the technologies that will be available in the future without limiting the scope of the invention.

In a further preferred embodiment, the perforated air cushions 110/130 and the nutrient bricks 120 disintegrate within a controlled time, while releasing the chemical compounds expected to be delivered by them. Preferably, any material that can be compatibly composted with plant substrate materials may be used as raw materials for the manufacturing of the aero rooter 100, the nutrient bricks 120, and any type of separators, or their alternatives comprising recycled cardboard, kraft papers, plant fibers, sawdust, wood chip, compressed compost, etc., or any alternative material compatible with the scope. The raw materials may further be comprised of binders, buffers, and any suitable material such as wax, to hold the rigidity of the aero rooter 100 from crumbling the shape before reaching the maturity of the plants grown.

In further preferred embodiments, the upper perforated air cushion 110 of the aero rooter 100 comprised of the plurality of nutrient brick 120 that may configure each one with at least one specific fertilizer supplementary chemical compound embedded or sprayed with a given amount based on plant-specific requirements. A method of embedding chemical compounds may comprise of any suitable raw material as previously described, a binding compound that helps the raw materials to mechanically bind and compressed to form desired shapes during manufacturing and to hold the desired amount of target chemical compound within the raw material that used as a buffer for the delivery, where the binding material may be a control-release chemical compound, or added as predefined amount with a suitable binder, wherein additional control-release barrier forming film may not be required. Alternatively, if the nutrient brick 120 is manufactured without any fertilizer embedded inside the nutrient brick 120, then the blank nutrient brick 120 is required to be sprayed, or dipped with the given fertilizer chemical compound to be absorbed into the surface within a predefined time period for the absorption of a given amount. Then oven dried, or use any alternative manufacturing process available for the general public, where the aero rooter 100, or the nutrient brick 120 may configure to apply a control-release chemical compound layer over the nutrient brick 120 in order to achieve the given objectives of the present invention.

In a further preferred embodiment, the nutrient brick 120 may be comprised of a water-soluble Sodium Molybdate [Na₂MoO₄] represented by (Mo) 810, Boric Acid [H₃BO₃] represent by (B) 820, Ferrous Sulfate [FeSO₄] represent by (Fe) 830, Magnesium Nitrate [Mg(NO₃)₂] represent by (Mg) 840, Manganese Sulfate [MnSO₄] represent by (Mn) 850, Zinc Sulfate [ZnSO₄] represent by (Zn) 860, Copper Sulfate [CuSO₄] represent by (Cu) 870, Calcium Chloride [CaCl₂)] represent by (Ca) 880. Further, the Chlorine (Cl) and Sulfur(S) are provided with given chemical compounds, whereas given chemicals or their individual contributions may not limit the scope of the invention as any commercially available secondary or micro required chemical compounds that are used as fertilizer formulas can be used as an alternative, or in addition, to reduce the chemical interreactions that may be taken place once dissolve in the water. Preferably, the nutrient bricks 120 may be distributed in the upper perforated air cushion 110 and the lower perforated air cushion 130, or only in the upper perforated air cushion 110 of the aero rooter 100 of the present invention.

According to the present invention, the nutrient bricks 120 may mostly be focused on providing secondary and micro required fertilizer varieties to the plant, whereas most of the fertilizer delivery systems and applications are commonly designed for the Nitrogen, Phosphorous, and Potassium (N, P. K) based fertilizers, thus manufactures add various amounts of secondary and micro required fertilizer varieties to the formula based on the compatibility and specific plant variety, or provide various generic formulas. Further, the micro or secondary fertilizer chemical compounds depletion may depend on the major chemical formulas provided as well as the chemical interreactions, thus requiring foliage applications or secondary applications depending on the environmental or climatic factors, where efficacy is very low and toxic conditions may develop if the micro or secondary required fertilizer have overdosed.

In a further preferred embodiment, water-soluble plant nutrients are easily absorbed by the plants and are easy to use, which are vital for plant growth and development. However, if the different chemical compounds providing various fertilizer cations and anions containing essential micronutrients such as Boron, Iron, Zinc, Manganese, Copper, Chlorine, Molybdenum, Nickel, Cobalt, and secondary fertilizers containing Sulfur, Magnesium, and Calcium are directly mixed into an irrigation system or fertigation system, there may be a number of unfavorable chemical reactions tend to take place, which may reduce the efficacy. Thus, the use of water-soluble micro and secondary fertilizers collectively has both advantages and disadvantages due to the chemical interactions that may occur in a water-based solution. Once dissolved in water, the ions can interact with each other in various ways such as forming complexes or precipitating out of solution, whereas acid-base reactions can also occur, affecting the pH of the solution and solubility of certain ions, which may also impact due to temperature fluctuations on the medium.

In addition or alternatively, the chemical reactions that may occur between water-soluble fertilizers can be complex and depend on a variety of factors, whereas even if a reaction occurs that reduces the absorption of a particular nutrient, there may still be sufficient levels of that nutrient available for the plant growth. Preferably, the control-release mechanism reduces the concentration of a specific chemical in the hydrated substrate due to slower release, which minimizes the availability in higher concentrations. Further, regular soil testing and monitoring are required for growers to identify nutrient deficiencies and adjust their fertilizer application as required, which may not be economically viable, or practically applicable for the potted plants as they may rather require external monitoring and preventive care with balanced supplies and improved application methods.

In a further preferred embodiment, the nutrient brick 120 may be configured to minimize quick release and the disadvantages of given chemical interreactions through the nutrient bricks 120, or any other alternative methods, including segregated spraying or embedding of an individual chemical compound followed by an application of a control-release chemical agent that can prevent quick release, where layer thickness of the chemical agent applied can control the duration of release. In a preferred embodiment, the nutrient brick 120 may further configure to control the individual release rates based on daily requirements of the specific plant grown on the hydrated substrate that are specific to each micro and secondary required fertilizer varieties, which can be controlled by controlling the thickness of the barrier film 1330 of the nutrient brick 120. In addition, or alternatively, the nutrient bricks 120 may be further prearranged to minimize the chemical interreactions during the watering of the plant due to the over-flooding of the substrate. Thus, the nutrient bricks 120 may configure with one chemical ingredient providing one or more micro or macro fertilizer cation/anion to the medium, which is required to control-release through the biodegradable chemical film according to the invention.

In a preferred embodiment, all the nutrient brick 120 may deposit in the upper perforated air cushion 110 when the plant pot has a wider top opening, which provides the wider diameter for the spacing between nutrient bricks 120 in the upper perforated air cushion 110 to reduce the chemical interreactions. Alternatively, or in addition, if the plant pot has a smaller top opening and a tall body, both the upper perforated air cushion 110 and the lower perforated air cushion 130 may hold nutrient bricks 120 prearranged to distance themselves more efficiently, while avoiding alignment one under another by configuring the slot opening 240 with most appropriate to the size of the aero rooter 100 design based on the standard commercial pot sizes and shapes available in the general market according to the invention.

Further preferably, the chemical compounds used to supplement fertilizer requirements may be pre-arranged based on their position in the periodic table, and the proven research findings on fertilizer applications in most efficient way possible to reduce such complex chemical interreactions before absorption into the plant roots. In line with the given examples, the upper perforated air cushion 110 may configure to hold the most reactive, or vulnerable chemical compounds, which may inhibit easily due to interreactions that may occur in the media with other chemical compounds as previously described. Thus, chemical compounds in the upper perforated air cushion 110 have to migrate through the substrate and roots, before they reach the lower perforated air cushion 130 to react with their counterpart ions, which provides more time for absorption before the reaction of both interreactive ions on the hydrated substrate, thus further reducing the opportunities for inhibitions. In addition, the nutrient bricks 120 prearrangement may further help to minimize the chemical interreactions during watering of the plant due to over-flooding of the substrate, where nutrient brick 120 may configure with one chemical ingredient providing one or more micro or secondary fertilizer anions/cations required through control-released barrier film 1330 according to the invention.

Preferably, the upper perforated air cushion 110 may configure to hold anions/cations of Boron (BO₃³⁻) Molybdenum (MoO₄²⁻), Magnesium (Mg²⁺), Iron (Fe²⁺/Fe³⁺), Sulfur (SO₄²⁻) and the lower perforated air cushion 130 may configure to hold anions/cations of Zinc (Zn²⁺), Manganese (Mn²⁺), Copper (Cu⁺/Cu²⁺), Chlorine (Cl⁻), Nickel (Ni²⁺), Cobalt (Co⁺²), Sulfur (SO₄²⁻) and Calcium (Ca²⁺). Further, the nutrient brick 120 may be organized within the perforated air cushions 110/130 to minimize chemical interreactions that are specific to any selected fertilizer chemical compound holding nutrient brick 120 and its left, right, and underneath, or above counterpart nutrient bricks 120 to be least reactive, or neutral fertilizer chemical compounds to obtain improved absorption efficacy.

In a further preferred embodiment, the following generic chemical quantities were used, and tested with the given examples based on the Cannabis sativa plant, whereas all the secondary fertilizers [Calcium (Ca), Magnesium (Mg), Sulfur(S)] added nutrient bricks 120 were configured with 1.5 g-2.0 g of the example chemical compound provided, while micro fertilizer [Iron (Fe), Manganese (Mn), Zinc (Zn), Copper (Cu), Boron (B), Molybdenum (Mo), and Chlorine (CI)] added nutrient bricks 120, were configured with 500 mg-1.0 g of the example chemical compounds provided. Alternatively, the scope of the given method may not be limited to the given examples, which may configure with any assisting components, or by any other means, without limitations to the scope of the present invention. Further, Nickel (Ni), and Cobalt (Co) were not necessary for the example trial plant used as well as most of the commercially grown plants except for a few specific varieties and specific geographical areas with deficiencies or the potting mix used.

Preferably, the nutrient brick 120 may further be sealed by an application of a control-release chemical compound that can prevent rapid release by film forming, which is partially permeable to air, moisture, and ion diffusion. Thus, when there is a concentration gradient of ions between two sides of the membrane/film, that causes the ions to move from the high concentration to the low concentration. Further, there are a number of control-release chemical compounds available in the general market, such as water-based emulsions that can be used for designing control-release functionality. One of such example water-based emulsion is Ethylene Vinyl Acetate (EVA) copolymer emulsion that uses EVA copolymer as the main ingredient, where EVA copolymer is a type of thermoplastic elastomer that is commonly used in a variety of applications, including adhesives, sealants, coatings, and films. The emulsion is made by mixing EVA copolymer pellets with water and a surfactant to create a stable emulsion. Thus, the resulting emulsion has a milky appearance and can be used as a binder or coating material in various applications. EVA copolymer emulsion has several advantages over solvent-based adhesives and coatings, including reduced volatile organic compound (VOC) emissions, improved environmental performance, and easy clean-up with water. EVA copolymer emulsion is commonly used in the production of packaging materials, paperboard coatings, laminating adhesives, and it is already used in the fertilizer industry to manufacture control-release/slow-release fertilizer products. Therefore, the EVA copolymer emulsion can be used as a control-release agent for the manufacture of micro and secondary fertilizer solutions. Preferably, there are several other control-release chemical agents available in the market as alternatives to the given example, which may also be used based on the fertilizer verity, specificity, manufacturing requirements, chemical formulas applied, and the mechanical properties required for different formulations without limitations to the scope.

Preferably, there are various control-release chemical compounds commercially available in the market that are commonly used in the fertilizer industry, where the invention was tested with Ethylene Vinyl Acetate (EVA) copolymer emulsion as an initial control-release chemical compound. The control-release mechanism of Ethylene Vinyl Acetate copolymer emulsion is based on the gradual breakdown of the emulsion over time, which releases the fertilizer in a controlled manner. The rate of breakdown and release can be controlled by adjusting several parameters, such as the EVA copolymer concentration, the emulsion droplet size, and the thickness of the emulsion layer. Further, the permeability of the film can be described as the product of the equilibrium solubility and diffusivity, which increased with decreasing EVA crystallinity in a linear manner, where a low polymer crystallinity may lead to a lower diffusivity with a higher solubility. Hence, a higher release rate can be achieved with a reduced layer thickness, while a lower release rate can be obtained with an increased layer thickness.

In a further preferred embodiment, the thickness of the EVA copolymer emulsion layer required to be carefully controlled, in order to achieve a specific time period for a release plan, whereas a thicker layer will generally result in a slower release rate, while a thinner layer will release more quickly. In addition, the temperature and humidity of the environment can also affect the release rate, hence such factors should also be considered when designing the control-release application. EVA copolymer emulsion can be an effective control-release agent for fertilizer applications that provides a reliable control-release mechanism for the nutrients over an extended period of time while minimizing the wastage and environmental impacts. Thus, considering all the given factors, the present invention applied a 300 μm-400 μm layer of EVA copolymer emulsion over the nutrient brick 120 as the most effective application for seasonal plants, which may require a thicker layer for the plants with longer life span while thinner layer may be required for the plants with shorter life span than four months. The used EVA copolymer emulsion had a viscosity ranging between 2000 to 3000 mPa*s, with pH 4-6, and >55% solid content without any dilutions.

In addition, or alternatively, the perforated air cushions 110 and 130 can be used explicitly for air pruning of roots as the basic function without delivery of any plant nutrients, as they are a set of air channels 430 sandwiched between the top surface 210/510 and bottom surface 330/610, where any of the perforated air cushions 110/130 can be used as a root air pruning device without any nutrient bricks 120, or segregated spraying or embedding of micro and secondary required fertilizer chemical compounds for the growth of plant root inside the plant pot.

In further preferred embodiments, the complete aero rooter 100 assembly may deposit inside a plant pot 1510, at least a few inches below an upper substrate level 1520, with various components of the provided embodiments therein, characterized by the upper perforated air cushion 110 and the lower perforated air cushion 130 with nutrient bricks 120. Further, the lower perforated air cushion 130 will be placed at the bottom of the plant pot 1510 prior to filling the plant pot with the substrate, where the upper perforated air cushion 110 may deposit after filling the plant pot 1510 at least 6 inches with the substrate, or half the pot height above the lower perforated air cushion 130, based on the plant pot 1510 height, which requires at least 3-4 inches of substrate layer on top of the upper perforated air cushion 110. Preferably, the lower perforated air cushion 130 may act as a water reservoir when the plant pot 1510 is flooded during the watering, where drained water can be collected and used without wasting, while it may also act as an aeration device for the substrate and roots therein.

In another preferred design configuration (design II), the aero rooter 100 may have alternative options for nutrient bricks 120, in which the aero rooter 100 may comprise of the upper perforated air cushion 110 and the lower perforated air cushion 130 with all the embodiments described in the previous example, except the plurality of nutrient brick 120, and the plurality of slot openings 240 for the reception of the nutrient bricks 120. Further, the upper perforated air cushion 110 and the lower perforated air cushion 130 may alternatively configure in the same process without nutrient brick 120 while offering an alternative to the method of application of micro and secondary required fertilizer varieties to the aero rooter 100. Alternatively, the upper perforated air cushion 110 and the lower perforated air cushion 130 may comprise a plurality of chemical compounds that are given in the previous example may be liquidized with water, and sprayed over the selected areas of the perforated air cushions 110 and 130, without crossing demarcated areas, to receive/achieve previously explained quantities of the secondary and micro required fertilizer compounds, which may dry using an oven, and seal the surface with the barrier film 1330 (EVA copolymer emulsion layer) sufficient to control the period of time designed for the release based on the specific plant requirements.

In further preferred embodiments, there may have several alternative optional methods for the fertilizer attachment, whereas another example method characterized by the application of the individual chemical compounds that may mix with the control-release chemical compounds instead of dissolving in water, where any alternative methods that are convenient for manufacturing methods will also include in the scope of the invention. Alternatively, or in addition, the upper perforated air cushion 110 and the lower perforated air cushion 130 may configure the individual pieces with embedded chemical compounds as a quarter (¼) or ⅕ of a perforated air cushion (110/130) separately and then combine the individual pieces together by any appropriate means to configure the perforated air cushions 110 and 130, which may dry using an oven and seal the surface with the barrier film 1330 (EVA Copolymer emulsion layer) sufficient to control the period of time designed for the release based on the specific plant requirements.

In another preferred alternative design example (design III), the aero rooter 100 may be characterized by a plurality of perforated layers stacked one under another/on top of each other, to configure upper perforated air cushion 110 and a plurality of perforated layers stacked one under another/on top of each other, to configure lower perforated air cushion 130 as an alternative option to the given perforated air cushions 110/130 in the previous examples, which may be comprised of the nutrient bricks 120 in the similar arrangement to the aero rooter 100, the initial design example (design I) explained, or other alternative design (design II) explained previously. Preferably, the upper perforated air cushion 110 and the lower perforated air cushion 130 both comprised of the plurality of apertures 220 on each layer with the slot opening 230. In addition, or alternatively, the individual perforated layers may configure with different micro or secondary fertilizers embedded or sprayed over as previously explained, which may configure to stack one under another to configure air channels 430 and the side openings for the roots to move around according to the present invention.

In a further preferred embodiment, the upper perforated air cushion 110 may characterize by a plurality of similar layers stacked on each other with a top perforated layer 3010 characterized by a similar wing identical to the wing 310, a perforated layer 3020 that may configure similar to the top perforated layer 3010 without the extended wing 310, stacked under the perforated top layer 3010 followed by a similar perforated layer 3030, and that may follow by a similar perforated layer 3040 to configure upper perforated air cushion 110 of the aero rooter 100. Preferably, the lower perforated air cushion 130 may also be configured almost similarly to the upper perforated air cushion 110 characterized by a perforated layer 3050 that may configure similarly to the perforated layer 3020 without the extended wing 310, followed by a similar perforated layer 3060 stacked under the perforated layer 3050, followed by a similar perforated layer 3070, and that may follow by a similar perforated layer 3080 to configure the lower perforated air cushion 130 of the invention.

Preferably, the top perforated layer 3010 of the acro rooter 100, that comprised of a plurality of protrusions 3110, a plurality of narrow openings 3120, a plurality of wider openings 3130 on the outer and the inner edge protrusions 3110 to configure more openings in the sides of the perforated air cushions 110/130, which may help penetrate the air and the plant roots into a plurality of air channels 3140 that facilitate the air pruning of roots and improvement of partial root growth. Further, the protrusion 3110 may configure with discontinuations to configure the plurality of narrow openings 3120 configured vertically that opens through both the top and bottom surface for the roots to penetrate through the embodiment for air pruning of roots to prevent apical dominance, and to improve oxygen supply, which further improves the partial root growth.

Preferably, the same fertilizer chemical compounds that were used in the previous example design to spray may be sprayed using the same process on the surfaces of both sides of the perforated layer from 3010 to the perforated layer 3080 as thin layers, or alternatively embedded within the perforated layers 3010 to 3080, with the same raw materials used in previously explained methods to manufacture the nutrient bricks 120, which may dry using an oven and seal the surface with the barrier film 1330 (EVA copolymer emulsion layer) sufficient to control the period of time designed for the release based on the specific plant requirements. Further, the protrusion 3110 stacked one under another, which may also help to bind the perforated layers 3010-3040, and the perforated layer 3050-3080, onto each other for stronger connectivity of the perforated air cushions 110/130 of the aero rooter 100.

In further preferred embodiments, each perforated layer form 3010 to 3080 of the aero rooter 100 of the alternative example (design III) may configure with at least one specific chemical compound embedded or sprayed, where upper perforated air cushion 110 of the given example comprised of the water-soluble Sodium Molybdate [Na₂MoO₄] represent by (Mo) 810 embedded in the layer 3010, Boric Acid [H₃BO₃] represent by (B) 820 embedded in the layer 3020, Ferrous Sulfate [FeSO₄] represent by (Fe) 830 embedded in the layer 3030, Magnesium Nitrate [Mg(NO₃)₂] represent by (Mg) 840 embedded in the layer 3040 as in the previous design examples. Preferably, the lower perforated air cushion 130 of the aero rooter 100 comprised of the water-soluble Manganese Sulfate [MnSO₄] represent by (Mn) 850 embedded in the layer 3050, Zinc Sulfate [ZnSO₄] represent by (Zn) 860 embedded in the layer 3060, Copper Sulfate [CuSO₄] represent by (Cu) 870 embedded in the layer 3070, Calcium Chloride [CaCl₂)] represent by (Ca) 880 embedded in the layer 3080. Further, the chlorine (Cl) and sulfur(S) are provided with given chemical compounds for the convenience of the application design, whereas given chemical compounds or their individual contributions may not limit the scope of the invention as any commercially available secondary or micro required chemical compounds that are used as fertilizer formulas can be used as alternatives, or to reduce the chemical interreactions that can be taken place once dissolve in the water.

In another preferred example alternative design (design IV), the aero rooter 100, characterized by at least one perforated air cushion 110, with at least one nutrient brick 120, configured to represent different plant nutrients including macro or micro category fertilizers to use in horticulture according to the invention. Preferably, the upper perforated air cushion 110 comprised of the top surface 210, the plurality of apertures 220 for the porosity of the upper perforated air cushion 110, the slot opening 230, the plurality of slot openings 240 as receptacles for the nutrient bricks 120. Further, the aero rooter 100 may comprise only the upper perforated air cushion 110 as a single unit application to deliver the required nutrients. Preferably, the upper perforated air cushion 110 may characterize by the wing 310 with the under surface 320, which may be an outward extension of the top surface 210 to create an air trap under the wing 310. In a further preferred embodiment, the upper perforated air cushion 110 comprised of the bottom surface 330 with the plurality of apertures 220 for the porosity of the bottom, the internal surface 410 with the protrusion 420, and the air channels 430 of the upper perforated air cushion 110, and the slot opening 230 that may cut through whole embodiment connecting the over and under substrate layers for improved plant growth.

Preferably, the aero rooter 100 of the given example may comprise only the upper perforated air cushion 110, whereas any lower perforated air cushions 130 of the previously explained designs (design I, II, and III) may alternatively use (without any nutrient bricks 120, or fertilizer sprayed, or embedded within it) as the lower perforated air cushion 130, which may act as a water reservoir when the plant pot 1510 is flooded during the watering, where drained water can be collected inside empty air channels 430 and reused without wasting, while it may also act as air pruning and aeration embodiment for the substrate and the roots therein. The example design may mostly be suited for the larger pots for more efficacy.

In a further preferred embodiment, the aero rooter 100 comprises of the plurality of nutrient brick 120 that may represent all the secondary and micro required fertilizers for plant growth. Each nutrient brick 120 may represent with at least one specific chemical compound attached by any appropriate means, where the given example comprised of the water-soluble Sodium Molybdate [Na₂MoO₄] represented by (Mo) 810, Boric Acid [H₃BO₃] represent by (B) 820, Ferrous Sulfate [FeSO₄] represent by (Fc) 830, Magnesium Nitrate [Mg(NO₃)₂] represent by (Mg) 840, Manganese Sulfate [MnSO₄] represent by (Mn) 850, Zinc Sulfate [ZnSO₄] represent by (Zn) 860, Copper Sulfate [CuSO₄] represent by (Cu) 870, Calcium Chloride [CaCl₂)] represent by (Ca) 880. Further, the chlorine (Cl) and the sulfur(S) are provided with given chemical compounds, whereas given chemicals or their individual contributions may not limit the scope of the invention as any commercially available secondary or micro required chemical compounds that are used as fertilizer formulas can be used as an alternative to further reduce the chemical interreactions that may be taken place once dissolve in the water. In a further preferred embodiment, the slot opening 240 may penetrate the bottom surface 330 with the smaller aperture 220 to support the holding of the nutrient brick 120, which may further help to prevent or minimize chemical interreactions when it leaches to the substrate that guides chemical descend downward with minimal interactions from nearby chemical compounds.

In a further preferred embodiment, the cylindrically/rectangularly configured hollow nutrient brick 120 that comprised of the hollow core 1310, the plurality of apertures 1320 spread around the hollow core 1310, and the barrier film 1330 to cover up the nutrient brick 120, which control-release the specific fertilizer variety embedded within the hollow core 1310 of the nutrient brick 120, during a 3-4 month growing season, or after the field planting with perineal plants, according to the present invention. Alternatively, the nutrient brick 120 may configure with any convenient shape or design according to the specific use and the preference of the manufacturer without deviating from the scope. Preferably, the nutrient brick 120 may be modified to deliver secondary and micro required fertilizer, as well as to ventilate the substrate, which may partially support air pruning of the roots, according to the present invention.

In a further preferred embodiment, the nutrient brick 120 may not only represent using the hollow rectangular or the hollow cylindrical shapes, where the scope will include all such modifications with any changes to the shape, or the size without changing the core objectivity of delivering macro and micro required fertilizer varieties to the plants.

In another preferred example alternative design, an alternatively configured nutrient platelet 6000, comprising similar components previously explained with various designs according to the invention. Preferably, the nutrient platelet 6000 is alternatively configured to function as a nutrient brick 120 to deliver secondary and micro required fertilizer, as well as to ventilate the substrate and provide partial air pruning to the plant roots, according to the present invention. In further preferred embodiments, the nutrient platelet 6000 comprised of the plurality of apertures 1320 spread around the nutrient platelet 6000 characterized by a wing 6010 identical to the wing 310, the plurality of protrusions 3110 that configure the plurality of air channels 3140 with the plurality of apertures 1320 spread around horizontally on the protrusion 3110, and with or without the barrier film 1330 to cover up the nutrient platelet 6000 for the control-release of fertilizer variety embedded within the hollow core 1310 of the nutrient platelet 6000 during a 3-4 month growing season, or after the field planting with perineal plants.

Further, the plurality of apertures 1320 spread around the nutrient platelet 6000 helps penetrate the air and the plant roots into a plurality of air channels 3140 that facilitate the air pruning of roots and improvement of partial root growth. Alternatively, or in addition, two or more of the nutrient platelets 6000, may be combined together with compatible nutrient platelets 6000 by any appropriate means for the deposition inside the plant pot 1510 while planting or transplanting according to the present invention. Further, the nutrient platelet 6000 may be a smaller embodiment applied in smaller pot designs, which may have several alternative design variations, without changes to the core objectives as shown in the rectangular-shaped example 6300 given in the drawings, wherein all such modifications are also included in the scope of the invention and used for the delivery of secondary and micro required fertilizer varieties to the plants grown in horticulture.

Preferably, the nutrient brick 120 may be modified to deliver secondary and micro required fertilizer and further configured to ventilate the substrate, which may partially support air pruning of the roots, according to the present invention. In a further preferred embodiment, the nutrient brick 120 may not only represent using the hollow rectangular and the hollow cylindrical shapes and the scope will include all such modifications with any changes to the shape or the size without changing the core objectivity of delivering macro and micro required fertilizer varieties to the plants.

In a further preferred embodiment, another example alternative design configured as rectangular/cylindrical shaped hollow nutrient brick 120, with various components therein explained previously according to the invention. The hollow nutrient brick 120 may configure as an elongated hollow tube 6500 to use as a horizontal or vertical air channel 430, the plurality of apertures 1320 around the hollow core 1310 for the porosity, and with or without the barrier film 1330 to cover up the elongated hollow tube 6500, which may control-release the specific fertilizer variety embedded within the elongated hollow tube 6500 during a 3-4 month growing season, or after the field planting with perineal plants. The nutrient brick 120 may configure with any convenient shape or design according to the specific use and the preference of the manufacturer without deviating from the scope. Preferably, the elongated hollow tube 6500 of the example may deposit during the transplanting on a vertical plane or, alternatively horizontal, or at any angle keeping at least one end of an air channel 430 connected to environmental air movements, which may also act as a partial air pruning and aeration component for the substrate and the roots therein.

In another preferred example alternative design, the plurality of nutrient bricks 120 may combine as a single embodiment by any appropriate means for the case of use in the field, or in the plant pots with various components therein explained previously according to the invention. The different fertilizer chemical compounds added nutrient bricks 120 may configure to combine two or more together by any appropriate means, with or without a separator 7210 or the barrier film 1330 to cover up the nutrient brick 120, which may control-release the specific fertilizer variety embedded within the individual nutrient brick 120 during a 3-4 month growing season, or after the field planting with perineal plants. Further, the separator 7210 may configure with the same raw materials as of the nutrient brick 120, but they do not have any fertilizer compounds embedded within it, which may use to provide separation of nutrient bricks 120 to reduce chemical interreactions, while releasing and before absorption to the plant roots.

In further preferred embodiments, the different fertilizer chemical compounds added nutrient bricks 120 may configure to combine two or more together by any appropriate means, with or without the separator 7210 or the barrier film 1330 to cover up the plurality of nutrient brick 120, which alternatively act as a group of multi-nutrient bricks 7300, that may control-release the specific fertilizer variety embedded within the individual nutrient brick 120 during a 3-4 month growing season, or after the field planting with perineal plants. Preferably, the group of multi-nutrient bricks 7300 may be deposited in two or more layers in the substrate with compatible fertilizer chemical compounds used in configuring the alternative group of multi-nutrient bricks 7300. Alternatively, or in addition, there are many other different ways of depositing a single brick or compatible multi-brick nutrition formulas inside a plant pot or in the field that are also covered in the scope of the invention.

In another preferred example alternative design, the nutrient bricks 120 may configure as a multi-nutrient brick air channel 7600, characterized by the plurality of nutrient bricks 120, separated by the plurality of separators 7210, at least one long hollow brick 7610 (another shape of a separator), configure to combine together with any appropriate means to use as an alternative air channel 7630 acting similar to the air channel 430, with the plurality of apertures 1320 around the hollow core 1310 for the porosity that may provide ventilation to the substrate by connecting outside air through the air channel 7620 with or without the barrier film 1330, which may control-release the specific fertilizer varieties embedded within the individual nutrient bricks 120 during a 3-4 month growing season, or after the field planting with perineal plants according to the invention.

In a further preferred embodiment, the long hollow brick 7610 may be configured to increase the distance between the upper group of multi-nutrient brick 7300 and the lower group of multi-nutrient brick 7300. The multi-nutrient brick air channel 7600 can be used periodically with perennial plants on the field, or when transplanting plants in the field or on plant pots. Preferably, the multi-nutrient brick air channel 7600 of the example may deposit during the transplanting on a vertical plane, or alternatively horizontal, or at any angle keeping at least one end of an air channel 7620 connected to environmental air movements, which may also act as a partial air pruning and aeration device for the substrate and the roots therein.

In further preferred embodiments, the individual nutrient bricks 120, or their alternatives may configure to deposit inside the plant pot 1510 in a single horizontal plane with or without any attachments. In another alternative example method, the nutrient brick 120 may arrange in a downward spiral, or any alternative method within the plant pot 1510, or around a transplanting tree in the field according to the invention.

### BRIEF DESCRIPTION OF THE DRAWINGS

The appended drawings contain figures of certain embodiments to further illustrate and clarify the above and other aspects, advantages, and features of the present invention. It will be appreciated that these drawings depict embodiments of the invention and are not intended to limit its scope. The invention will be described and explained with additional specificity and detail through the use of the accompanying drawings for a more complete understanding, where references are made to the following descriptions and accompanying drawings, in which:

FIG. 01 depicts a perspective front view of an aero rooter assembly with all prescribed embodiments together, before depositing inside a plant pot according to the invention.

FIG. 02 depicts a plan view of an upper perforated air cushion of an aero rooter assembly according to the invention.

FIG. 03 depicts a bottom view of an upper perforated air cushion of an aero rooter assembly according to the invention.

FIG. 04 depicts a plan view of an interior without the top perforated layer of an air cushion of an aero rooter assembly according to the invention.

FIG. 05 depicts a plan view of a lower perforated air cushion of an aero rooter assembly according to the invention.

FIG. 06 depicts a front view of an aero rooter assembly according to the invention.

FIG. 07 depicts a side view of an aero rooter assembly according to the invention.

FIG. 08 depicts a perspective exploded view of an aero rooter assembly in accordance with the present invention.

FIG. 09 depicts a cross-section across the middle of an aero rooter assembly according to the invention.

FIG. 10 depicts a perspective front view of a cross-section across the middle of an aero rooter assembly according to the invention.

FIG. 11 depicts a perspective bottom view of an aero rooter assembly according to the invention.

FIG. 12 depicts a perspective front view of a nutrient brick according to the invention.

FIG. 13 depicts a perspective front view of a cylindrical nutrient brick with a barrier layer according to the invention.

FIG. 14 depicts a perspective front view of a cubical nutrient brick with a barrier layer according to the invention.

FIG. 15 depicts a cross-section of an aero rooter assembly with all prescribed embodiments together, after depositing inside a plant pot according to the invention.

FIG. 16 depicts a plan view of an aero rooter assembly with all prescribed embodiments together, after depositing inside a plant pot according to the invention.

FIG. 17 depicts a perspective view of the cross-section of an aero rooter assembly with all prescribed embodiments together, after depositing inside a plant pot according to the invention.

FIG. 18 depicts a perspective front view of an alternatively configured aero rooter assembly, before depositing inside a plant pot according to the invention.

FIG. 19 depicts a perspective bottom view of an alternatively configured aero rooter assembly, before depositing inside a plant pot according to the invention.

FIG. 20 depicts a front view of an alternatively configured aero rooter assembly, before depositing inside a plant pot according to the invention.

FIG. 21 depicts a plan view of an alternatively configured aero rooter assembly according to the invention.

FIG. 22 depicts a bottom view of an alternatively configured aero rooter assembly according to the invention.

FIG. 23 depicts a cross-section across the middle of an alternatively configured aero rooter assembly according to the invention.

FIG. 24 depicts a perspective view of a cross-section across the middle of an alternatively configured aero rooter assembly according to the invention.

FIG. 25 depicts a perspective exploded view of an alternatively configured aero rooter assembly in accordance with the present invention.

FIG. 26 depicts a cross-section of an alternatively configured aero rooter assembly with prescribed embodiments together, after depositing inside a plant pot according to the invention.

FIG. 27 depicts a plan view of an aero rooter assembly with prescribed embodiments together, after depositing inside a plant pot according to the invention.

FIG. 28 depicts a perspective front view of the cross-section of an aero rooter assembly with prescribed embodiments together, after depositing inside a plant pot according to the invention.

FIG. 29 depicts a perspective front view of an alternatively configured aero rooter assembly according to the invention.

FIG. 30 depicts a perspective upside-down view of an alternatively configured aero rooter assembly according to the invention.

FIG. 31 depicts a perspective upside-down view of an alternatively configured top perforated layer of the upper perforated air cushion of an aero rooter assembly according to the invention.

FIG. 32 depicts a perspective upside-down view of an alternatively configured top perforated layer of the lower perforated air cushion of an aero rooter assembly according to the invention.

FIG. 33 depicts a plan view of an alternatively configured top perforated layer of the upper perforated air cushion of an aero rooter assembly according to the invention.

FIG. 34 depicts a bottom view of an alternatively configured top perforated layer of the upper perforated air cushion of an aero rooter assembly according to the invention.

FIG. 35 depicts an upside-down front view of an alternatively configured aero rooter assembly according to the invention.

FIG. 36 depicts a cross-section across the middle of an alternatively configured aero rooter assembly according to the invention.

FIG. 37 depicts a perspective cross-section across the middle of an alternatively configured aero rooter assembly according to the invention.

FIG. 38 depicts a perspective exploded view of an alternatively configured aero rooter assembly in accordance with the present invention.

FIG. 39 depicts a cross-section of an alternatively configured aero rooter assembly with prescribed embodiments together, after depositing inside a plant pot according to the invention.

FIG. 40 depicts a plan view of an aero rooter assembly with prescribed embodiments together, after depositing inside a plant pot according to the invention.

FIG. 41 depicts a perspective side view of the cross-section of an alternatively configured aero rooter assembly with prescribed embodiments together, after depositing inside a plant pot according to the invention.

FIG. 42 depicts a perspective front view of an alternatively configured aero rooter, before depositing inside a plant pot according to the invention.

FIG. 43 depicts a plan view of an alternatively configured aero rooter according to the invention.

FIG. 44 depicts a bottom view of an alternatively configured aero rooter, before depositing inside a plant pot according to the invention.

FIG. 45 depicts a front view of an alternatively configured aero rooter, before depositing inside a plant pot according to the invention.

FIG. 46 depicts a side view of an alternatively configured aero rooter, before depositing inside a plant pot according to the invention.

FIG. 47 depicts a perspective view of a cross-section across the middle of an alternatively configured aero rooter according to the invention.

FIG. 48 depicts a perspective bottom view of an alternatively configured aero rooter according to the invention.

FIG. 49 depicts a perspective exploded view of an alternatively configured aero rooter in accordance with the present invention.

FIG. 50 depicts a cross-section of an alternatively configured aero rooter with prescribed embodiments together, after depositing inside a plant pot according to the invention.

FIG. 51 depicts a plan view of an aero rooter with prescribed embodiments together, after depositing inside a plant pot according to the invention.

FIG. 52 depicts a perspective front view of the cross-section of an aero rooter with prescribed embodiments together, after depositing inside a plant pot according to the invention.

FIG. 53 depicts a perspective front view of a cylindrical nutrient brick with a barrier layer according to the invention.

FIG. 54 depicts a front view of a cylindrical nutrient brick with a barrier layer according to the invention.

FIG. 55 depicts a sectional view of a cylindrical nutrient brick with a barrier layer according to the invention.

FIG. 56 depicts a perspective front view of the cross-section of a cylindrical nutrient brick with a barrier layer according to the invention.

FIG. 57 depicts a perspective front view of a cubical nutrient brick with a barrier layer according to the invention.

FIG. 58 depicts a plan view of a cubical nutrient brick with a barrier layer according to the invention.

FIG. 59 depicts a sectional perspective view of a cubical nutrient brick with a barrier layer according to the invention.

FIG. 60 depicts a plan view of a circular nutrient platelet without a barrier layer according to the invention.

FIG. 61 depicts a perspective bottom view of an upside-down circular nutrient platelet without a barrier layer according to the invention.

FIG. 62 depicts a perspective view of an upside-down circular nutrient platelet without a barrier layer according to the invention.

FIG. 63 depicts a plan view of an alternatively configured rectangular nutrient platelet without a barrier layer according to the invention.

FIG. 64 depicts a perspective upside-down view of an alternatively configured rectangular nutrient platelet without a barrier layer according to the invention.

FIG. 65 depicts a perspective front view of an alternatively configured rectangular shaped nutrient brick with a barrier layer according to the invention.

FIG. 66 depicts a front view of an alternatively configured rectangular shaped nutrient brick with a barrier layer according to the invention.

FIG. 67 depicts a sectional perspective view of an alternatively configured rectangular shaped nutrient brick with a barrier layer according to the invention.

FIG. 68 depicts a perspective front view of an alternatively configured cylindrical shaped nutrient brick according to the invention.

FIG. 69 depicts a front view of an alternatively configured cylindrical shaped nutrient brick with a barrier layer according to the invention.

FIG. 70 depicts a sectional perspective view of an alternatively configured cylindrical shaped nutrient brick with a barrier layer according to the invention.

FIG. 71 depicts a perspective front view of an alternatively configured rectangular shaped multi-nutrient brick with a barrier layer according to the invention.

FIG. 72 depicts a perspective front view of an alternatively configured rectangular shaped multi-nutrient brick with a separator, and without a barrier layer according to the invention.

FIG. 73 depicts a perspective front view of an alternatively configured rectangular shaped group of multi-nutrient bricks with separators according to the invention.

FIG. 74 depicts a front view of an alternatively configured rectangular shaped multi-nutrient brick with a barrier layer according to the invention.

FIG. 75 depicts a sectional perspective view of an alternatively configured rectangular shaped multi-nutrient brick with a barrier layer according to the invention.

FIG. 76 depicts a perspective front view of an alternatively configured multi-nutrient brick air channel with a barrier layer according to the invention.

FIG. 77 depicts a front view of an alternatively configured multi-nutrient brick air channel with a barrier layer according to the invention.

FIG. 78 depicts a sectional perspective view of an alternatively configured multi-nutrient brick air channel with a barrier layer according to the invention.

FIG. 79 depicts a perspective bottom view of an alternatively configured multi-nutrient brick air channel with a barrier layer according to the invention.

FIG. 80 depicts a plan view of an alternatively configured multi-nutrient brick air channel with a barrier layer according to the invention.

FIG. 81 depicts a bottom view of an alternatively configured multi-nutrient brick air channel with a barrier layer according to the invention.

FIG. 82 depicts a perspective exploded view of an alternatively configured multi-nutrient brick air channel in accordance with the present invention.

FIG. 83 depicts a cross-section of an alternatively configured multi-nutrient brick air channel with prescribed embodiments together, after depositing inside a plant pot according to the invention.

FIG. 84 depicts a plan view of an alternatively configured multi-nutrient brick air channel with prescribed embodiments together, after depositing inside a plant pot according to the invention.

FIG. 85 depicts a perspective front view of the cross-section of an alternatively configured multi-nutrient brick air channel with prescribed embodiments together, after depositing inside a plant pot according to the invention.

FIG. 86 depicts a plan view of an alternative method of using nutrient bricks, after depositing them inside a plant pot according to the invention.

FIG. 87 depicts a perspective view of the cross-section of an alternative method of using nutrient bricks, after depositing inside a plant pot according to the invention.

FIG. 88 depicts a cross-section of an alternative method of using nutrient bricks, after depositing them inside a plant pot according to the invention.

FIG. 89 depicts a perspective view of the cross-section of another alternative method of using nutrient bricks, after depositing inside a plant pot according to the invention.

FIG. 90 depicts a cross-section of another alternative method of using nutrient bricks, after depositing them inside a plant pot according to the invention.

FIG. 91 depicts a plan view of an example method of using multi-nutrient brick, after depositing it inside a plant pot according to the invention.

FIG. 92 depicts a cross-section of an example method of using multi-nutrient brick, after depositing it inside a plant pot according to the invention.

FIG. 93 depicts a perspective view of the cross-section of an example method of using multi-nutrient brick, after depositing it inside a plant pot according to the invention.

FIG. 94 depicts a cross-section of an example method of using rectangularly elongated nutrient brick, after depositing it inside a plant pot according to the invention.

FIG. 95 depicts a plan view of an example method of using rectangularly elongated nutrient brick, after depositing it inside a plant pot according to the invention.

FIG. 96 depicts a perspective view of the cross-section of an example method of using rectangularly elongated nutrient brick, after depositing it inside a plant pot according to the invention.

FIG. 97 depicts a cross-section of an example method of using cylindrically elongated nutrient brick, after depositing it inside a plant pot according to the invention.

FIG. 98 depicts a plan view of an example method of using cylindrically elongated nutrient brick, after depositing it inside a plant pot according to the invention.

FIG. 99 depicts a perspective view of the cross-section of an example method of using cylindrically elongated nutrient brick, after depositing it inside a plant pot according to the invention.

### DETAILED DESCRIPTION OF THE INVENTION

The present invention will be disclosed using the preferred embodiments and appended drawings to provide a better understanding of the technical features, contents, impacts, methods, and advantages of the present invention. However, the appended drawings are merely schematic representations, which may not be illustrated according to the actual scale and precise arrangement of the present invention, where the scope of protection of the present invention will not be based on the scale and arrangement illustrated on the appended drawings and limited thereto.

The term “plant” includes any part, tissue, and organ originating from any plant, such as agricultural commercial, ornamental plants as well as plant parts that may include a fruit, a flower, a tuber, a root, a stem, a leaf, a seed, etc.

The term “plant pot” includes any device or container intended to grow plants for agricultural, commercial, industrial, or ornamental purposes that are available in many shapes and with attachments.

The term “water” does not necessarily mean pure water, which may include any liquid containing water or dilutions of nutrient solutions, organic brews, municipal water, etc.

The term “aero rooter” means was derived considering a device that can be used for plant root aeration, which will influence excessive partial root growth with the use of passive air.

The term “air cushion” means a device or system that uses a layer of compressed air between two surfaces to reduce friction, was applied here considering the similar structure, but not the exact mechanical simulation.

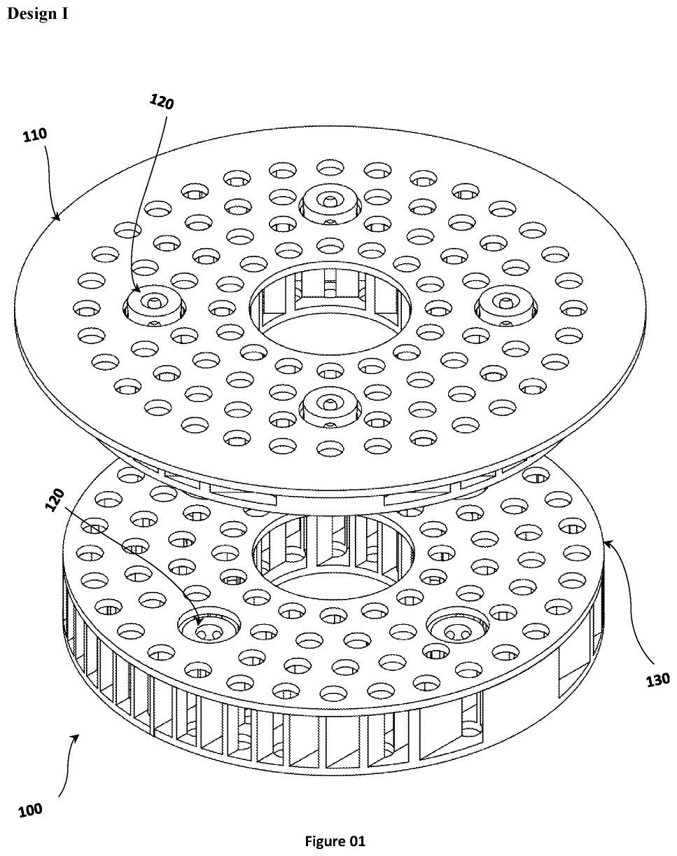

FIG. 01 depicts the perspective front view of an aero rooter 100 assembly according to the invention, preferably, the aero rooter 100 assembly comprised of an upper perforated air cushion 110, a plurality of nutrient bricks 120 attached therein characterized by different plant nutrients including macro or micro category fertilizers, and a lower perforated air cushion 130 almost similar to the upper perforated air cushion 110 with the nutrient bricks 120 attached therein for the application in horticulture.

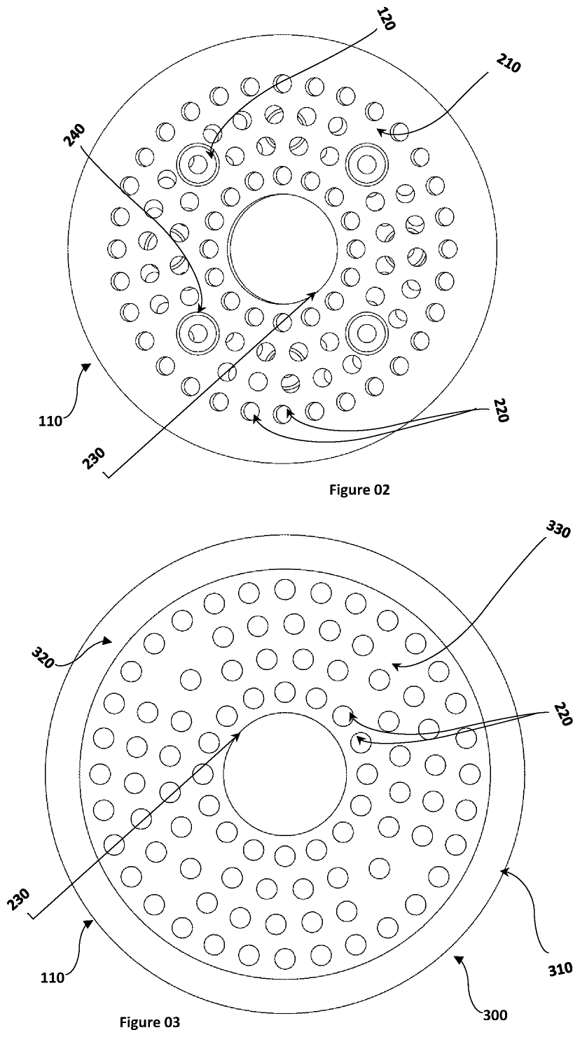

FIG. 02 depicts the plan view 200 of the upper perforated air cushion 110 of the aero rooter 100 according to the invention. Preferably, the upper perforated air cushion 110 characterized by a top surface 210, a plurality of apertures 220 for the porosity of the surface, at least one slot opening 230 configured in the mid area, and a plurality of slot openings 240 for the reception of nutrient bricks 120.

FIG. 03 depicts the bottom view 300 of the upper perforated air cushion 110 according to the invention. The upper perforated air cushion 110 may characterize by a wing 310 with an under surface 320, which may be an outward extension of the top surface 210 to create an air trap connecting all air pockets to the external air movement through cracks between the substrate and the sidewall of a plant pot. In a further preferred embodiment, the upper perforated air cushion 110 comprised of a bottom surface 330, with the plurality of apertures 220 for the porosity of the bottom of the upper perforated air cushion 110, and the slot opening 230 that may cut through the whole embodiment connecting the over and under substrate layers for improved plant growth.

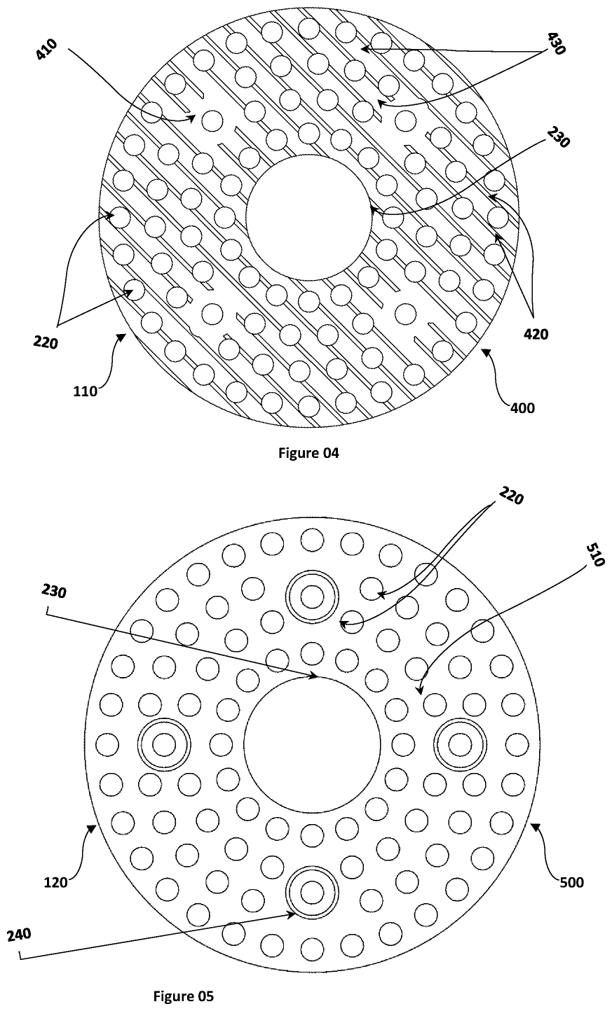

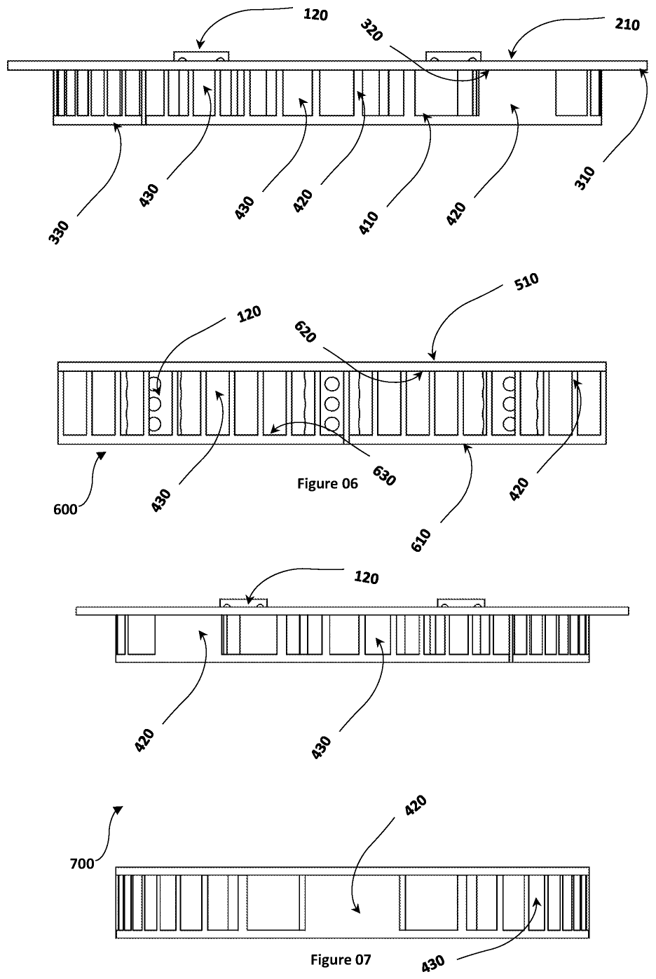

FIG. 04 depicts the plan view 400 of an upper perforated air cushion 110 without the top surface 210, according to the invention that illustrates the internal structure characterized by an internal surface 410, the plurality of apertures 220 for the porosity of the surface, the slot opening 230, and a plurality of protrusions 420, which configures a plurality of air channels 430. FIG. 06 the front view 600, and FIG. 07 the side view 700, further illustrate the air channels 430, sandwiched in between the top surface 210 and the bottom surface 330 horizontally, where the sidewalls created by the protrusion 420 on the internal surface 410 may form the upper perforated air cushion 110 that traps air inside the plurality of air channels 430 for air pruning of the plant roots to prevent apical dominance, which further improves the partial root growth.

FIG. 05 depicts the plan view 500 of a lower perforated air cushion 130 of the aero rooter 100 assembly according to the invention. The lower perforated air cushion 130 may be almost similar in configuration to the upper perforated air cushion 110, which also comprised of a top surface 510 almost similar to the top surface 210 of the upper perforated air cushion 110 without the wing 310, the plurality of apertures 220 for the porosity of the surface, the slot opening 230 for substrate continuity within the plant pot and the plurality of slot openings 240 for the reception of nutrient bricks 120.

Preferably, the difference between the upper perforated air cushion 110 and the lower perforated air cushion 130 may be very minimal, whereas the lower perforated air cushion 130 does not have an extension creating the wing 310 of the upper perforated air cushion 110 to create an air pocket between the ends of the air channels 430 and the plant pot wall, which help the lower perforated air cushion 130 to reach the bottom of the pot, or as lowest as possible in any given shape of a plant pot and the corresponding lower perforated air cushion 130.

FIG. 06, the front view 600, and FIG. 07, the side view 700 of the aero rooter 100 further illustrate the protrusion 420, the air channels 430, the top surface 210, and the bottom surface 330 configured in the upper perforated air cushion 110. Preferably, the lower perforated air cushion 130 also comprised of the top surface 510, a bottom surface 610, an under surface 620, and an internal surface 630 similar to the internal surface 410, configured to form the protrusion 420, which creates vertical barrier walls to form the air channels 430 inside the upper perforated air cushion 110 that traps atmospheric air inside the air channels 430. Further preferably, the protrusion 420 may dissect due to the apertures 220 configured vertically, which opens through both the top surface 210/510 and bottom surface 330/610 for roots to penetrate through the embodiments for air pruning of roots to prevent apical dominance, and to improve oxygen supply, which further improves the partial root growth.

In addition, both FIG. 06, the front view 600, and FIG. 07, the side view 700 depict the aero rooter 100 may be configured with the lower perforated air cushion 130 taller than the upper perforated air cushion 110 in order to create an extended empty space inside a plant pot at the bottom, which may create a shallow water reservoir at the bottom of the plant pot that provides uninterrupted water supply to the plant, where leached fertilizers or any other additives may have extended time period for absorption through the root system. Further, the end user must keep his pot bottom seamless by skipping the drilling of the drainage apertures at the pot bottom, where he should make an alternative aperture, or two in the side wall slightly below the top surface 510 of the lower perforated air cushion 130 for excessive water to overflow, provide an inlet for ambient air, and wash the substrate as well as to remove excess gases and salts accumulated as necessary. Preferably, the slot opening 230 may configure to create a solid substrate column that can absorb water through capillary action when the upper substrate layers are evaporated or absorbed by the plant roots.

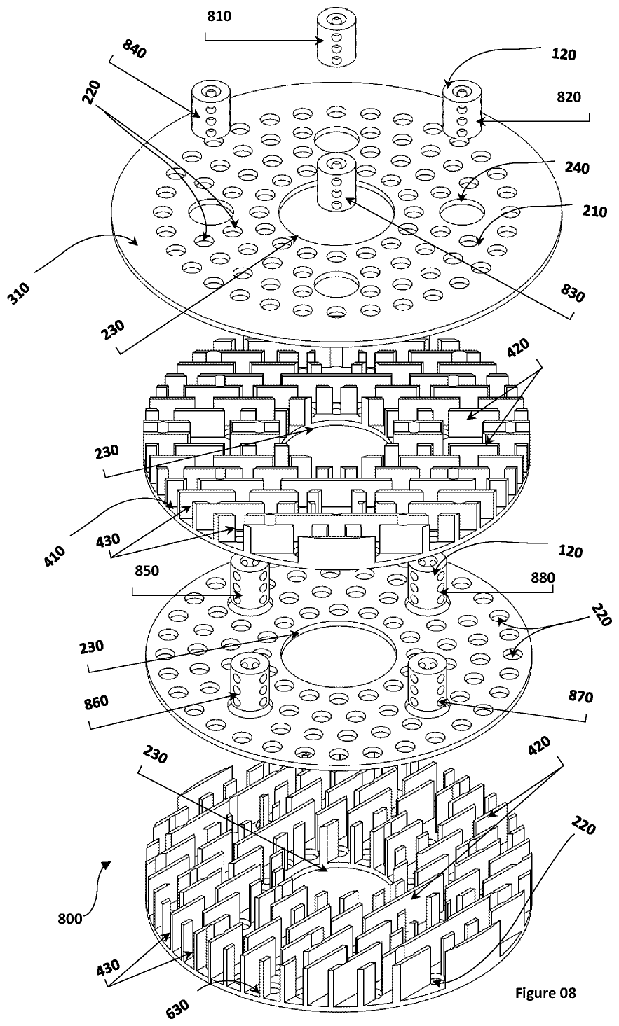

FIG. 08 depicts the exploded view 800 of an aero rooter 100, wherein the exploded view 800 further depicts the internal and external views of the upper perforated air cushion 110, the nutrient bricks 120, and the lower perforated air cushion 130 in a segmented view from top to the bottom in several layers that illustrate the similar structures inside with all the previously described embodiments therein. In further preferred embodiments, the upper perforated air cushion 110 of the given example acro rooter 100 comprised of the plurality of nutrient brick 120 that may configure each one with at least one specific chemical compound attached by any appropriate means, where the nutrient brick 120 comprised of the water-soluble Sodium Molybdate [Na₂MoO₄] represent by (Mo) 810, Boric Acid [H₃BO₃] represent by (B) 820, Ferrous Sulfate [FeSO₄] represent by (Fc) 830, Magnesium Nitrate [Mg(NO₃)₂] represent by (Mg) 840.

Preferably, FIG. 08 further illustrates that the lower perforated air cushion 130 of the acro rooter 100 also comprised of the plurality of nutrient brick 120 that may configure each one in the same method with at least one specific chemical compound attached by any appropriate means, where the nutrient brick 120 comprised of the water-soluble Manganese Sulfate [MnSO₄] represent by (Mn) 850, Zinc Sulfate [ZnSO₄] represent by (Zn) 860, Copper Sulfate [CuSO₄] represent by (Cu) 870, Calcium Chloride [CaCl₂)] represent by (Ca) 880. Further, the Chlorine (CI) and Sulfur(S) are provided with given chemical compounds, whereas given chemical compounds or their individual contributions may not limit the scope of the invention as any commercially available secondary or micro required fertilizer chemical compounds that are used as fertilizer formulas can be used as an alternative, or in addition, to reduce the chemical interreactions that may be taken place once dissolve in the water. In a further preferred embodiment, the nutrient bricks 120 should not be vertically aligned to each other while planting of the upper perforated air cushion 110 and the lower perforated air cushion 130 to minimize/prevent inhibition due to inter-chemical reactions tend to take place before absorption takes place if they were vertically aligned.

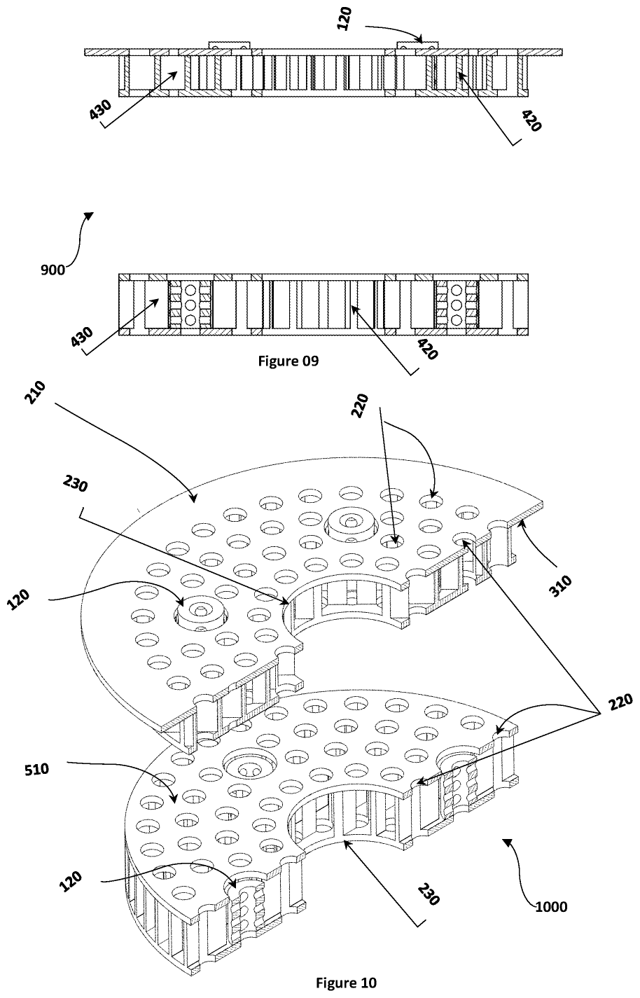

FIG. 09 and FIG. 10 depict the sectional front view 900 and the sectional perspective front view 1000 of the aero rooter 100 assembly according to the present invention. Both drawings portray the sectional view of the aero rooter 100 in order to illustrate how various components of the provided embodiments may fit together in the given example. As all the provided numerals are already explained in the previously referenced drawings, only the necessary explanations are provided below with the sectional views.

Preferably, the upper perforated air cushion 110 and the lower perforated air cushion 130 may configure with the apertures 220 that penetrate the whole embodiment to pass through to the other side as depicted in both FIG. 09 and FIG. 10. In addition, the slot opening 230 configured on both the upper and the lower perforated air cushions 110/130 also penetrate to the other side of the embodiment as illustrated in FIG. 10, which helps to keep the substrate connected through the embodiments, while creating additional openings for roots to penetrate into the perforated air cushions 110/130 for air pruning to increase the density of roots and absorption of nutrients.

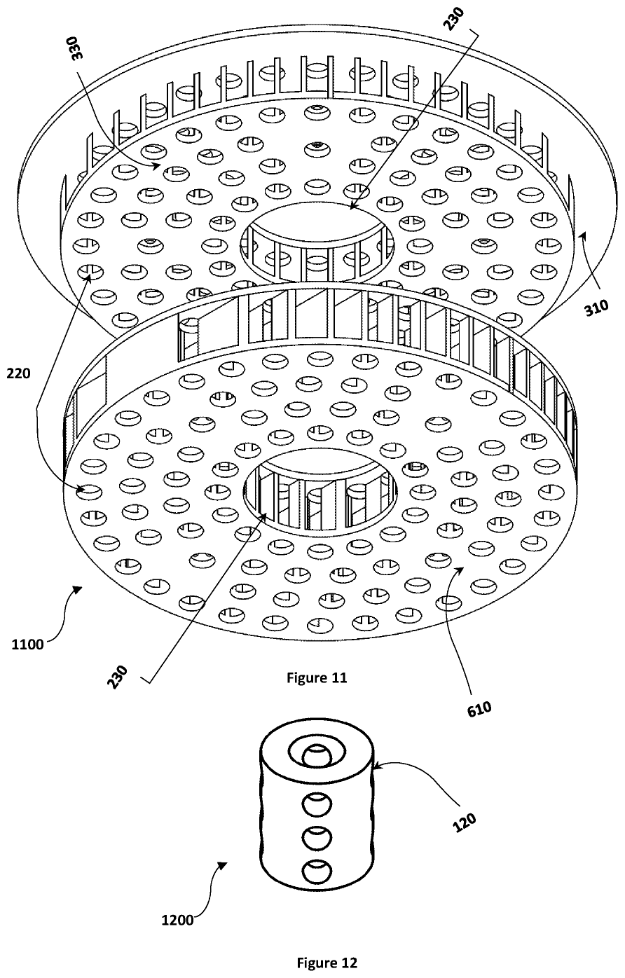

FIG. 11 depicts the perspective bottom view 1100 of an aero rooter 100 assembly according to the invention. In a further preferred embodiment, the perspective bottom view 1100 further illustrates the wing 310 of the upper perforated air cushion 110, the bottom surface 610 of the lower perforated air cushion 130, and the slot openings 230 of the upper perforated air cushion 110 and the lower perforated air cushion 130, which may take any shape or it may not be identical to each other with or without the slot opening 230 in any of the upper perforated air cushion 110, 130, or both.

FIG. 12 and FIG. 13 depict the perspective front views of 1200 and 1300 of a cylindrical nutrient brick 120 with various components configured therein according to the present invention. In a further preferred embodiment, as FIG. 13 depicts the expanded perspective front view of the nutrient brick 120 that may be comprised of a hollow core 1310, a plurality of apertures 1320 spread around the hollow core 1310, and a barrier film 1330 to cover up the nutrient brick 120, which control-release the specific fertilizer variety embedded within the hollow core 1310 of the nutrient brick 120, during a 3-4 month growing season, or after the field planting with perineal plants. Further, the shape of the nutrient brick 120 may configure with any convenient shape or design compatible with available manufacturing technologies currently in the market, or the technologies that will be available in the future without limiting the scope of the invention.

Preferably in one embodiment, FIG. 14 depicts a perspective front view 1400 of a cubically configured nutrient brick 120 with previously explained components therein, that may be alternatively used for the purpose of delivering different nutrient varieties to a plant. Preferably, there are no limits to the shape of the nutrient brick 120, which can be formed in any convenient shape with at least one macro or micro plant fertilizer variety attached therein by any appropriate means to the nutrient brick 120 with an extended surface area.

According to the present invention, the nutrient bricks 120 may mostly focus on providing secondary and micro required fertilizer varieties to the plant, because most of the fertilizer delivery systems and applications are commonly designed for Nitrogen, Phosphorous, and Potassium (N. P. K) based fertilizers, thus manufactures add various amounts of secondary and micro required fertilizer varieties to the formula based on the compatibility, and specific plant verity, or a generic formula. Further, the secondary and micro required fertilizer chemical depletion may depend on the provided major chemical formulas as well as chemical interreactions, thus requiring foliage applications, or secondary applications depending on the environmental or climatic factors, where efficacy is very low and toxic conditions may develop if the micro or secondary required fertilizer are overdosed.

Preferably, water-soluble plant nutrients are easily absorbed and easy to use, but there may be unfavorable chemical reactions between them if directly applied with a higher concentration than required in an irrigation system or a fertigation system inhibiting or reducing the availability, where frequent supplies or a control mechanism may be required as micro fertilizers contain essential micronutrients such as Boron (20 to 60 ppm), Iron (2 to 10 ppm), Zinc (15 to 60 ppm), Manganese (20 to 300 ppm), Copper (4 to 6 ppm), Chlorine (0.1 to 1 ppm), Molybdenum (0.01 to 0.5 ppm), Nickel (0.05 to 1 ppm), and secondary fertilizers containing Sulfur (20 to 40 ppm), Magnesium (50 to 100 ppm), and Calcium (150 to 250 ppm) that are vital for plant growth and development.

In addition, there are some advantages and disadvantages of using water-soluble micro and secondary fertilizers due to the chemical interreactions that occur in a water-based solution. When water-soluble micro or secondary fertilizers are dissolved in water, the dissolved ions can interact with each other in various ways. One of the most common interreactions is the formation of complexes, which occur when two or more ions bind together to form a stable compound. Another common interreaction is precipitation, which occurs when an ion becomes insoluble and precipitates out of the solution, which can occur when the concentration of an ion exceeds its solubility limit, or when the pH, or the temperature of the solution changes and that causes the ion to become insoluble or soluble. For example, if the pH of the solution becomes too alkaline, calcium and magnesium can precipitate out of the solution as calcium carbonate and magnesium hydroxide respectively. Acid-base reactions can also occur in water-soluble micro or secondary fertilizer chemicals, which can affect the pH of the solution and the solubility of certain ions. For example, if an acidic fertilizer is added to basic soil, the fertilizer can neutralize some of the soil's basicity and lower the pH, which can increase the solubility of certain nutrients, such as iron and manganese, which are more readily available at lower pH levels.

Preferably, optimization of nutrient availability is essential for achieving optimal crop growth and yields in modern agriculture, where water-soluble fertilizers, containing both micronutrients and secondary nutrients play a crucial role in providing plants with essential elements required for proper development. Further, the interactions between these nutrients may significantly influence their effectiveness and impact on plant health. Thus, micronutrients are generally considered to be enzyme activators in plants, where an enzyme requires a specific micronutrient to activate, which is referred to as a catalyst, whereas all the micronutrients, B, Cu, Fe. Mn, Mo, and Zn, except chlorine, are activators of specific enzymes. On the other hand, excessive levels of phosphorus, calcium (high pH), zinc, and copper may cause a manganese deficiency. Further, iron and zinc may reduce copper availability, where copper, manganese, and zinc may reduce iron availability, and copper, iron, and zinc may reduce manganese availability. Further, excessive calcium can cause reduced availability of other nutrients due to increased pH, where excessive Calcium may also lead to magnesium deficiency symptoms in plants due to the competition between divalent cations at plant roots, which may lead to antagonistic effects. Nonetheless, lower pH levels can increase the availability of certain nutrients such as iron and manganese. Nonetheless, chelation involves the formation of stable complexes between metal ions (micronutrients) and organic molecules, where Chelating agents, such as ethylenediaminetetraacetic acid (EDTA), enhance the solubility and availability of micronutrients. For example, iron can form complexes with various ligands, such as EDTA or DTPA, where chelated iron (Fe-EDTA) prevents iron from forming insoluble compounds in alkaline soils, increasing its uptake by plants that prevents the iron from precipitating out of the solution.

Preferably, the chemical reactions that may occur between water-soluble fertilizers can be complex and depend on a variety of factors, whereas even if a reaction occurs that reduces the absorption of a particular nutrient, there may still be sufficient levels of that nutrient available for plant growth. However, the control-release mechanism reduces the concentration of any specific given chemical in the hydrated substrate due to slower release, which minimizes the availability in higher concentrations. Further, regular soil testing and monitoring are required for growers to identify nutrient deficiencies and adjust their fertilizer application as required, which may not be economically viable, or practically applicable for the potted plants as they may rather require external monitoring and preventive care with balanced supplies and improved application methods.

In a further preferred embodiment, the nutrient bricks 120 are configured to minimize any potential chemical interactions through the nutrient bricks 120, or alternatively segregated spraying of an individual chemical compound followed by an application of a control-release chemical agent that can prevent the quick release, while layer thickness of the chemical agent can control the duration of release. In addition, or alternatively, the nutrient bricks 120 may further prearrange to minimize any potential chemical interreactions that may be possible during watering of the plant pot due to over-flooding of the substrate, where nutrient brick 120 may configure with one chemical ingredient providing one or two, micro or secondary fertilizer cation/anion required through control-released chemical barrier film 1330 according to the invention. Preferably, the upper perforated air cushion 110 may configure to hold Boron (BO₃³⁻) Molybdenum (MoO₄²⁻), Magnesium (Mg²⁺), Iron (Fe²⁺/Fe³⁺), Sulfur (SO₄²⁻), and the lower perforated air cushion 130 may configure to hold Zinc (Zn²⁺), Manganese (Mn²⁺), Copper (Cu⁺/Cu²⁺), Chlorine (Cl⁻), Nickel (Ni²⁺), Sulfur (SO₄²⁻), and Calcium (Ca²⁺) further organizing within the perforated air cushions 110/130 to minimize chemical interreactions that may specific to any selected fertilizer compound holding nutrient brick 120 and its left, right and underneath or above nutrient bricks 120 to hold different fertilizer chemical compounds that are minimally reactive or neutral to each other for improved absorption efficacy.

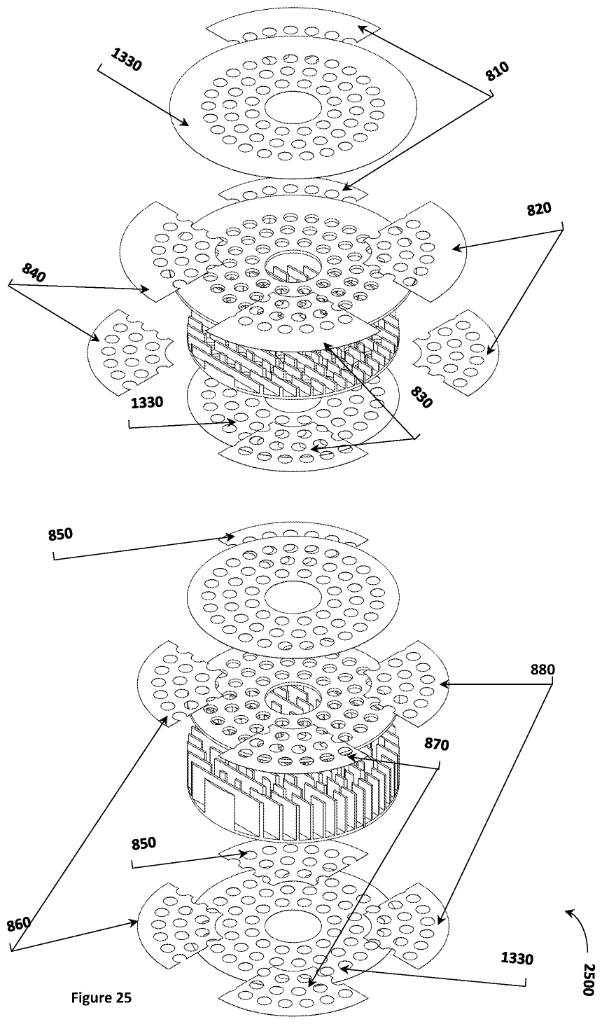

Further, the nutrient brick 120 may be organized as in FIG. 08, or alternatively sprayed onto the surface as depicted in FIG. 25 to reduce the interreactions of water-soluble chemical compounds applied based on the formula. Hence, some of the alternative ways of using the aero rooter 100 and nutrient brick 120, or their alternatives will be discussed with relevant appended drawings.

Preferably in one embodiment, the upper perforated air cushion 110 may comprise of any regular water soluble micro and secondary fertilizer chemical compounds available in the market that provides Molybdenum (Mo) as MoO₄²⁻ ions, Boron (B) as BO₃³⁻ ions, Iron (Fe) as Fe²⁺ (ferrous) and Fe³⁺ (ferric) ions, Magnesium (Mg) as Mg²⁺ ions, and Sulfur(S) as SO₄²⁻ ions, where each nutrient brick 120 may provide at least one fertilizer cation or anion to the plant, while some may provide one or more depending on the plant requirements, and the availability of commercial fertilizer chemical formulas. In addition, or alternatively, the lower perforated air cushion 130 may comprise of any regular water-soluble micro and secondary chemical compounds available in the market that provides Manganese (Mn) as Mn²⁺ ions, Zinc (Zn) as Zn²⁺ ions, Copper (Cu) as Cu⁺ and Cu²⁺ ions, Calcium (Ca) as Ca²⁺ ions, Chlorine (Cl) as Cl⁻ ions, Sulfur(S) as SO₄²⁻ ions, Nickel (Ni) as Ni²⁺ ions, and Cobalt (Co) Co²⁺ ions considering plant-specific requirements and potting mix used.

Preferably, the following chemical quantities were used for the given example, which was designed and tested based on the Cannabis sativa plant, wherein all the secondary fertilizer [Calcium (Ca), Magnesium (Mg), Sulfur(S)] added nutrient bricks 120 were configured with 1.5 g-2.0 g of the example chemical compound provided, while micro fertilizer [Iron (Fe), Manganese (Mn), Zinc (Zn), Copper (Cu), Boron (B), Molybdenum (Mo), Chlorine (Cl)] added nutrient bricks 120 were configured with 500 mg-1.0 g of the example chemical compounds provided. Alternatively, the scope of the given method may not be limited to the given examples, which may configure with any assisting components, or by any other means, not limiting the scope of the present invention. Further, Nickel (Ni), and Cobalt (Co) were not necessary for the example trial plant used as well as most of the commercially grown plants except for a few specific varieties and specific geographical areas with deficiencies or the potting mix used.

Preferably, the nutrient brick 120 was further sealed with an application of a control-release chemical compound that can prevent the rapid release by reducing the water absorption through the film forming around the exposed surface, which is partially permeable to air, moisture, and ion diffusion, but resistant to water absorption that reduces the hydration of water-soluble fertilizer chemical compounds. Thus, reduction of ion diffusion by limiting the availability of high concentrations of the dissolved ions, because if there is a concentration gradient of ions between two sides of the membrane/film, the higher concentration causes the ions to move from the high concentration to the low concentration.

Further, there are a number of control-release chemical compounds available in the general market, such as water-based emulsions that can be used for designing control-release functionality. One of such example water-based emulsion is Ethylene Vinyl Acetate (EVA) copolymers that use the EVA copolymer as the main ingredient, where EVA copolymer is a type of thermoplastic elastomer that is commonly used in a variety of applications, including adhesives, sealants, coatings, and films. The emulsion is made by mixing EVA copolymer pellets with water and a surfactant to create a stable emulsion. The resulting emulsion has a milky appearance and can be used as a binder or coating material in various applications. EVA copolymer emulsion has several advantages over solvent-based adhesives and coatings, including reduced volatile organic compound (VOC) emissions, improved environmental performance, and easy to clean up with water. EVA copolymer emulsion is commonly used in the production of packaging materials, paperboard coatings, laminating adhesives, and it is already used in the fertilizer industry to manufacture control-release fertilizer products. Therefore, the EVA copolymer emulsion can be used as a control-release agent for control-release fertilizer solutions. Preferably, there are several other control-release chemical agents available in the market as alternatives to the given example, which may also be used based on the fertilizer variety, specificity, chemical formulas applied, and the mechanical properties required for the different formulations without limitations to the scope.

Preferably, the control-release mechanism of EVA copolymer emulsion is based on the gradual breakdown of the emulsion over time, which releases the fertilizer in a controlled manner. The rate of breakdown and release can be controlled by adjusting several parameters, such as the EVA copolymer concentration, the emulsion droplet size, and the thickness of the emulsion layer. Further, the permeability can be described as the product of the equilibrium solubility and diffusivity, which increased with decreasing EVA crystallinity in a linear manner, where a low polymer crystallinity may lead to a lower diffusivity with a higher solubility. Hence, a higher release rate can be achieved with a reduced layer thickness, while a reduced release rate can be obtained with an increased layer thickness.

In a further preferred embodiment, the thickness of the EVA copolymer emulsion layer required to be carefully controlled, in order to achieve a specific time period for a release plan, whereas a thicker layer will generally result in a slower release rate, while a thinner layer will release more quickly. In addition, the temperature and humidity of the environment can also affect the release rate, hence such factors should be considered when designing the control-release barrier film 1330. Preferably. EVA copolymer emulsion can be an effective control-release agent for fertilizer application, providing a controlled release of nutrients over an extended period of time, while minimizing waste and environmental impact. Thus, considering all the given factors, the present invention applied a 300 μm-400 μm layer over the nutrient brick 120 as the most effective application for seasonal plants, which may require a thicker layer for the plants with longer life spans while thinner layer may be required for the plants with shorter life span than four months. The used EVA copolymer emulsion had a viscosity ranging between 2000 to 4000, with pH 4-6, and >55% solid content without any dilutions.

In addition, or alternatively, the perforated air cushions 110 and 130 can be used explicitly for air pruning of roots as the basic function without delivery of any plant nutrients, as they are a set of air channels 430 sandwiched between the top and the bottom surfaces, where any of the perforated air cushions 110/130 can be used as a root air pruning device without any nutrient bricks 120, or segregated spraying or embedding of micro and secondary required fertilizer chemical compounds for the plant root growth inside the plant pot.

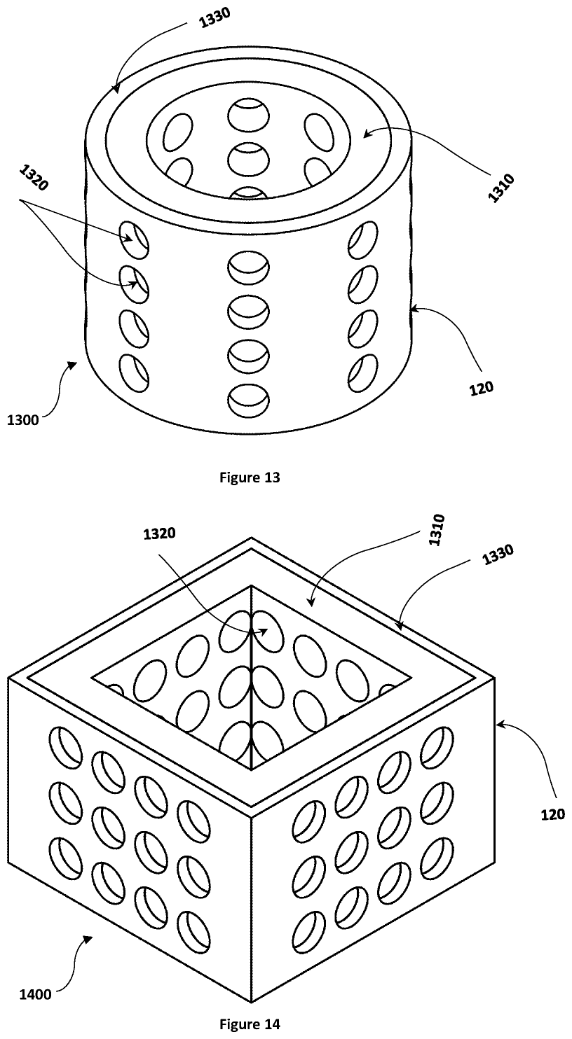

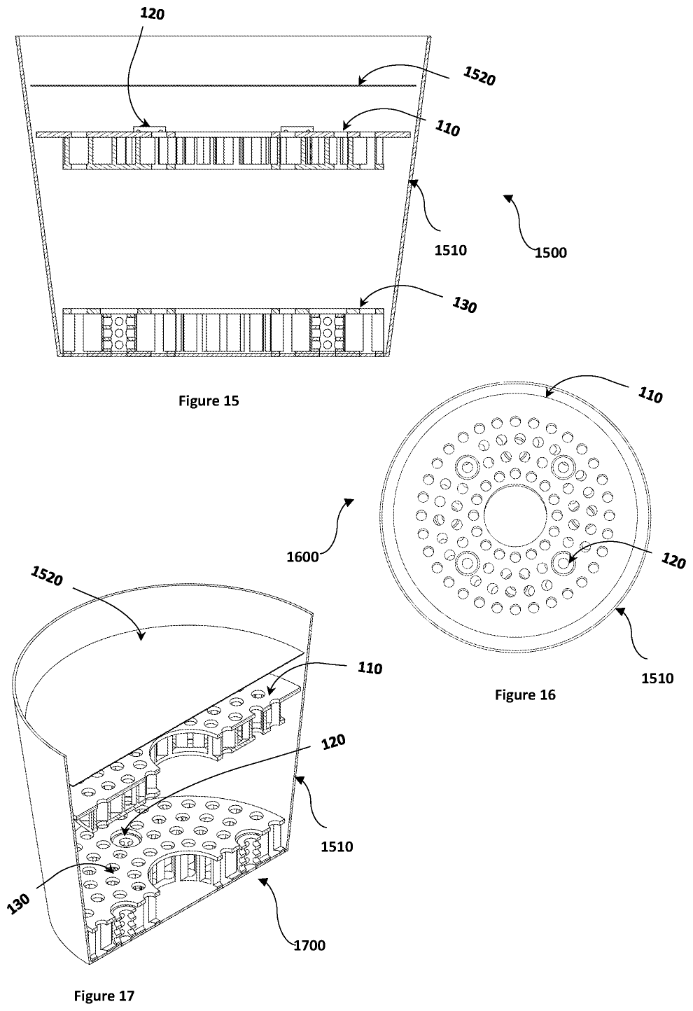

FIG. 15, FIG. 16, and FIG. 17 depict the sectional view 1500, the plan view 1600, and the sectional perspective front view 1700 of an example aero rooter 100 assembly deposited inside a plant pot 1510 below a substrate level 1520 with the upper perforated air cushion 110, the nutrient bricks 120 and the lower perforated air cushion 130 according to the present invention. Further, the lower perforated air cushion 130 will be placed at the bottom of the plant pot 1510 prior to filling the plant pot with the substrate, where the upper perforated air cushion 110 may deposit after filling the plant pot 1510 at least half the pot height (at least 6 inches) with the substrate, or above the lower perforated air cushion 130, based on the plant pot 1510 height, which requires at least few inches (3-4 inches) of substrate layer on top of the upper perforated air cushion 110. FIG. 16 portrays the plan view without the substrate 1520 inside the plant pot 1510 for visibility. As FIG. 17 further depicts, the lower perforated air cushion 130 may act as a water reservoir when the plant pot 1510 is flooded during the watering, where drained water can be collected and used without wasting, while it may act as an aeration device for the substrate and roots therein once the water is absorbed back to the substrate.

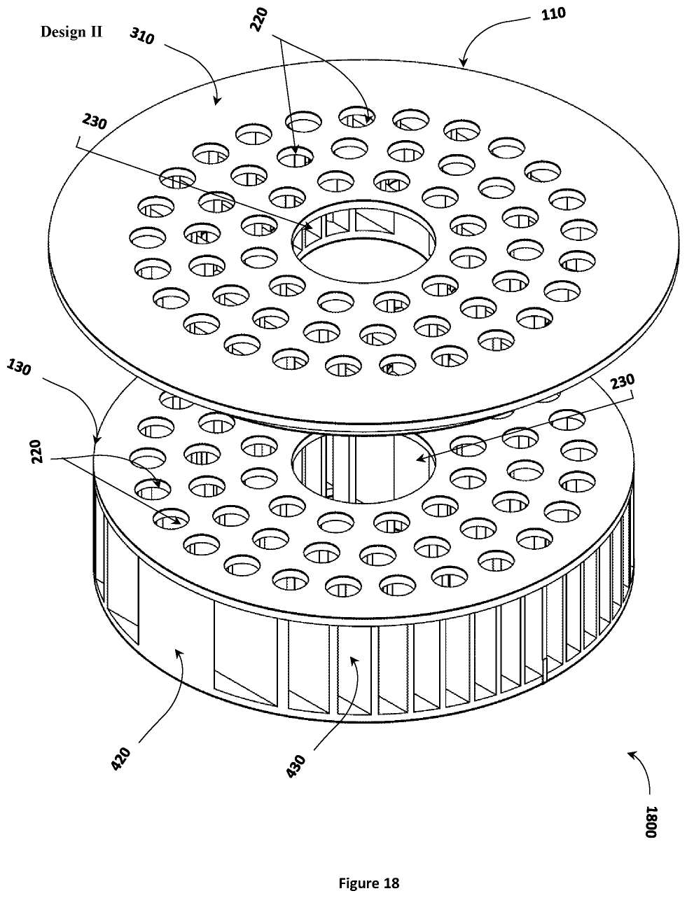

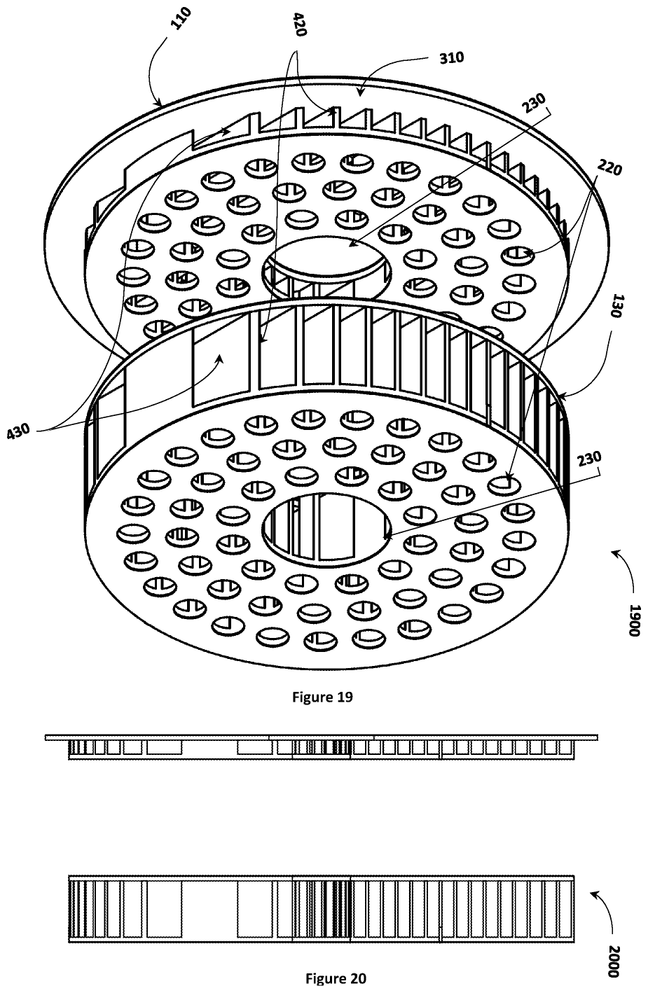

FIG. 18, FIG. 19, and FIG. 20 depict the perspective front view 1800, the perspective bottom view 1900, and the front view 2000 of an alternative example aero rooter 100 (design II) design that may be configured with an alternative option for nutrient bricks 120, which comprised of the upper perforated air cushion 110 and the lower perforated air cushion 130 with all the components described with previous drawings except the plurality of nutrient brick 120, and the plurality of slot openings 240 for receiving of the nutrient bricks 120. Alternatively, the upper perforated air cushion 110 and the lower perforated air cushion 130 comprised a plurality of segregated layers of previously described micro and secondary fertilizer chemical compounds sprayed over the top surfaces (210/510) and the bottom surfaces (330/610) of each perforated air cushion (110/130) with the same formulas using similar methods and given quantities in the previous design example. Thus, the same numerals (810 to 880) are used with the only difference in application method, wherein the given chemical compounds are dissolved in water and sprayed over the selected areas of the perforated air cushions 110 and 130 rather than provided as nutrient brick 120, according to the invention. In further preferred embodiments, there may be several alternative optional methods for the application, another example method characterized by the application of the individual fertilizer chemical compounds that may mix with the control-release chemical compounds instead of dissolving in water, whereas any alternative methods that are convenient for manufacturing technology, will also be included in the scope of the invention. Alternatively, or in addition, the upper perforated air cushion 110 and the lower perforated air cushion 130 may configure the individual pieces with embedded chemical compounds as a quarter (¼) or ⅕ of a perforated air cushion 110 or 130 separately, and then combine the separate pieces together by any appropriate means to configure the perforated air cushions 110 and 130, which may dry using an oven and then seal the surface with the barrier film 1330 sufficient to control the period of time designed for the release based on the specific plant requirements.

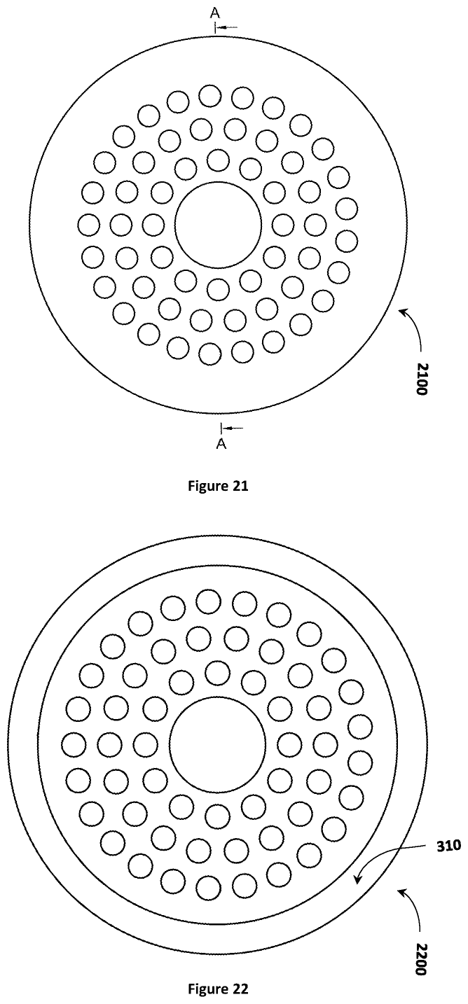

FIG. 21 depicts the plan view 2100 of the aero rooter 100 without nutrient bricks 120 or the slot openings 240 as the receptacles for the nutrient bricks 120 according to the invention.

FIG. 22 depicts the bottom view 2200 of the aero rooter 100 with the wing 310 to configure an empty space around the air channel 420 according to the invention.

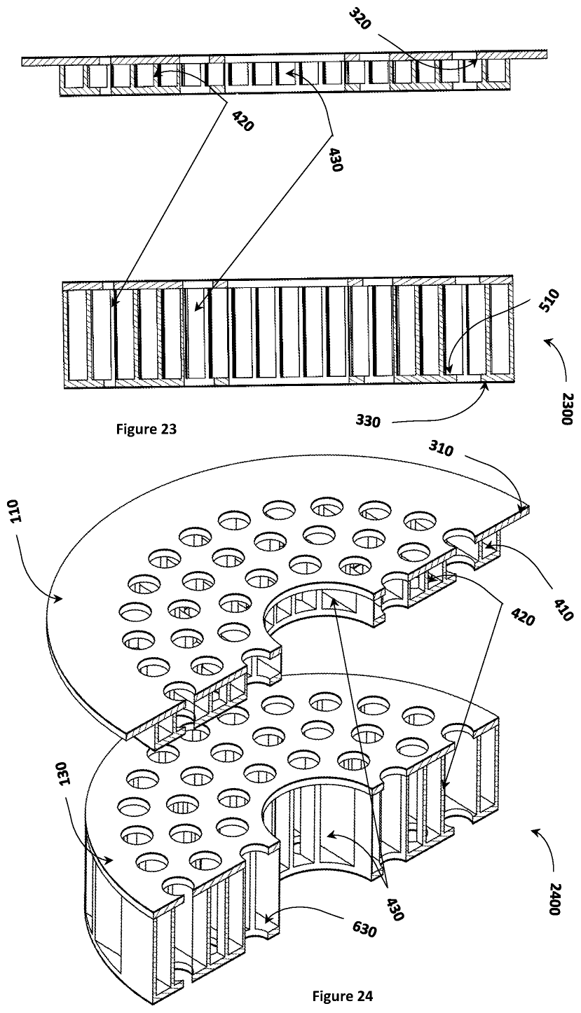

FIG. 23 the cross-sectional view 2300, and FIG. 24 the perspective front view of a cross-section 2400 depict the aero rooter 100 with the wing 310 to configure an empty space around the air channels 430 according to the invention. Further, the protrusion 420 are originated from the internal surface 410, which may configure as described previously to form the air channels 430 inside the perforated air cushions 110/130 according to the present invention. In addition, or alternatively, the perforated air cushions 110 and 130 can be used explicitly for air pruning of roots as the basic function without delivery of any plant nutrients, as they are a set of air channels 430 sandwiched between the top and the bottom surfaces, where any of the perforated air cushions 110/130 can be used as a root air pruning device without any nutrient bricks 120, or segregated spraying or embedding of micro and secondary required fertilizer chemical compounds for the plant root growth inside the plant pot 1510.

In addition or alternatively, the lower perforated air cushion 130 may configure taller than the upper perforated air cushion 110 of the previous design I explained, to improve the water retainability by acting as a water reservoir due to empty spaces configured inside the air channels 430 once the plant pot 1510 is watered.

FIG. 25 depicts the exploded view 2500 of the aero rooter 100, wherein the exploded view 2500 further depicts the internal and external views of the upper perforated air cushion 110, the lower perforated air cushion 130 without nutrient bricks 120, or the plurality of slot openings 240 as receptacles, in a segmented view from top to the bottom in several layers that illustrate the similar structure inside with all the previously described embodiments therein. Alternative to the nutrient bricks 120, the same fertilizer chemical compounds used in the previous example design may spray over at least one side of the perforated air cushions 110/130 as thin layers, which may dry using an oven and seal the surface with the thin barrier film 1330 (EVA Copolymer layer in the given example) sufficient to control the period of time designed for the release based on the specific plant requirements. In further preferred embodiments, the perforated air cushion 110/130 of the aero rooter 100 may configure with segregated areas over the top surfaces (210/510) and the bottom surfaces (330/610) of each perforated air cushion (110/130) with at least one specific chemical compound sprayed or embedded (attached by any appropriate means), where the upper perforated air cushions 110 of the given example comprised of the water-soluble Sodium Molybdate [Na₂MoO₄] represent by (Mo) 810, Boric Acid [H₃BO₃] represent by (B) 820, Ferrous Sulfate [FeSO₄] represent by (Fc) 830, Magnesium Nitrate [Mg(NO₃)₂] represent by (Mg) 840.

Preferably, the lower perforated air cushion 130 of the aero rooter 100 is also configured in the same process as of the upper perforated air cushion 110, without the plurality of nutrient brick 120, or the slot opening 240, with at least one specific chemical compound sprayed or embedded (attached by any appropriate means), where given example comprised of the water-soluble Manganese Sulfate [MnSO₄] represent by (Mn) 850, Zinc Sulfate [ZnSO₄] represent by (Zn) 860, Copper Sulfate [CuSO₄] represent by (Cu) 870, Calcium Chloride [CaCl₂)] represent by (Ca) 880. Further, the chlorine (Cl) and sulfur(S) are provided with given chemical compounds, whereas given chemicals or their individual contributions may not limit the scope of the invention as any commercially available secondary or micro required fertilizer chemical compounds that are used as fertilizer formulas can be used as an alternative, or in addition, to reduce any possible chemical interreactions that can be taken place once dissolve in the water.

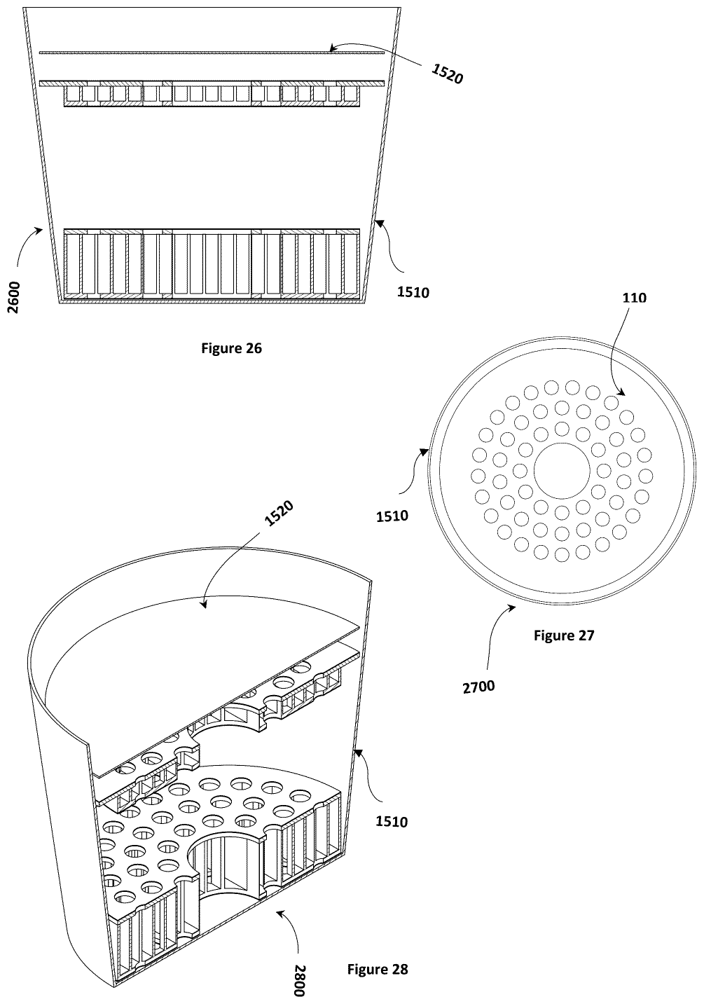

FIG. 26, FIG. 27, and FIG. 28 depict the sectional view 2600, the plan view 2700, and the sectional perspective front view 2800 of the given alternative design example of the aero rooter 100 assembly (design II) deposited inside the plant pot 1510 below the substrate level 1520 with the upper perforated air cushion 110, and the lower perforated air cushion 130 according to the present invention. FIG. 26 further portrays how various components of the provided embodiments may fit together within the plant pot 1510 under the substrate level 1520, characterized by the upper perforated air cushion 110 and the lower perforated air cushion 130 deposited within the substrate, which may be sprayed with the chemical compounds explained previously as of the given example. FIG. 27 portrays the plan view without the substrate 1520 inside the plant pot 1510 for visibility. As FIG. 28 further depicts, the lower perforated air cushion 130 may act as a water reservoir when the plant pot 1510 is flooded during the watering, where drained water can be collected inside empty air channels 430 and used back without wasting, while it may also act as an aeration device for the substrate and roots therein.

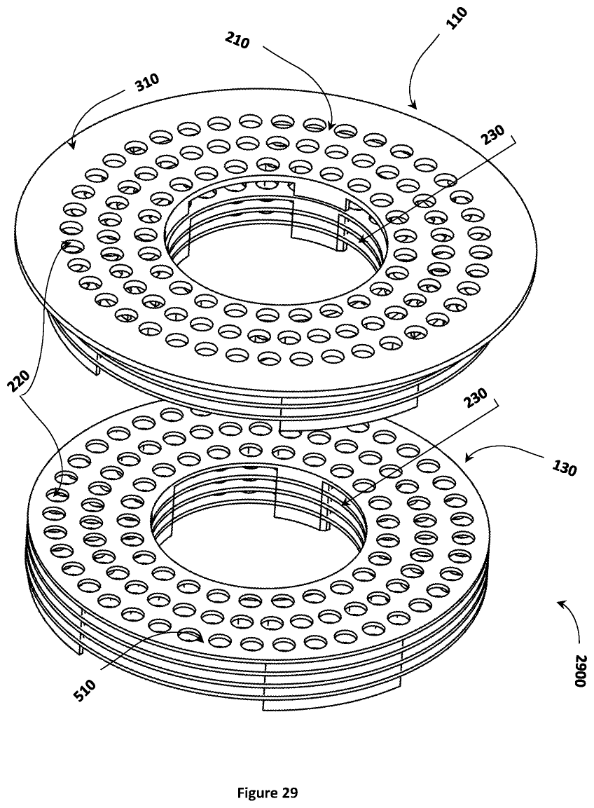

FIG. 29, depicts the perspective front view 2900 of another example alternative design of the aero rooter 100 (design III) characterized by a plurality of perforated layers stacked one under another, to configure upper perforated air cushion 110 and a plurality of perforated layers stacked one under another, to configure lower perforated air cushion 130 as an alternative option for the previously given perforated air cushions 110/130, which may comprise of nutrient bricks 120 in the similar design to the initial example design (design I) explained, or other alternative example design (design II) explained previously. Preferably, the perforated air cushions 110 and 130 both comprised of the plurality of apertures 220 on each layer with at least one larger slot opening 230 for the reception of a transplant. In addition, or alternatively, the individual perforated layers may configure with different micro or secondary fertilizers embedded, or sprayed over as previously explained, which may configure to stack on top of each other/one under another, to configure air channels 430 and the side openings for the roots to move around and inside the aero rooter 100 according to the present invention.

In a further preferred embodiment, FIG. 30, depicts the perspective upside-down view 3000 of the stacked upper perforated air cushion 110 characterized by four similar layers stacked one under another with a top perforated layer 3010 characterized by the wing 310 identical to the previous designs, a perforated layer 3020 that may configure similar to the top perforated layer 3010 without the extended wing 310 that is stacked under the perforated top layer 3010 followed by a perforated layer 3030 similar to the perforated layer 3020, and that may follow by a similar perforated layer 3040 to configure the upper perforated air cushion 110 of the aero rooter 100. Preferably, the lower perforated air cushion 130 may also configure almost similarly to the upper perforated air cushion 110 characterized by a perforated layer 3050 that may configure similarly to the perforated layer 3020 without the extended wing 310, followed by a similar perforated layer 3060 stacked under the perforated layer 3050, followed by a similar perforated layer 3070, and that may follow by a similar perforated layer 3080 to configure the lower perforated air cushion 130 of the invention. Alternatively, or in addition, any of the perforated layers 3020 to 3080 other than the top perforated layer 3010 of the upper perforated air cushion 110 and the lower perforated air cushion 130 may configure with or without the extended wing 310.

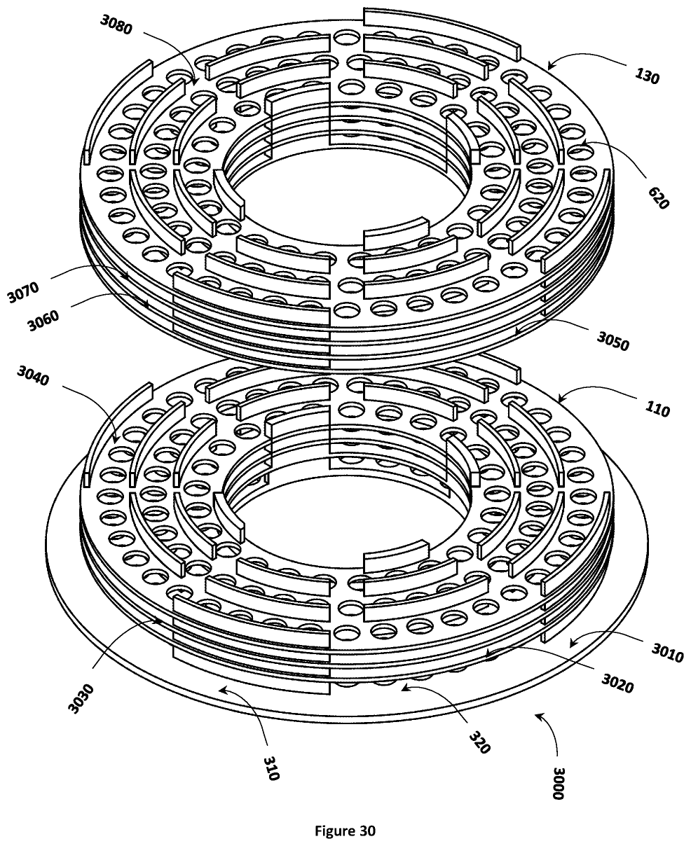

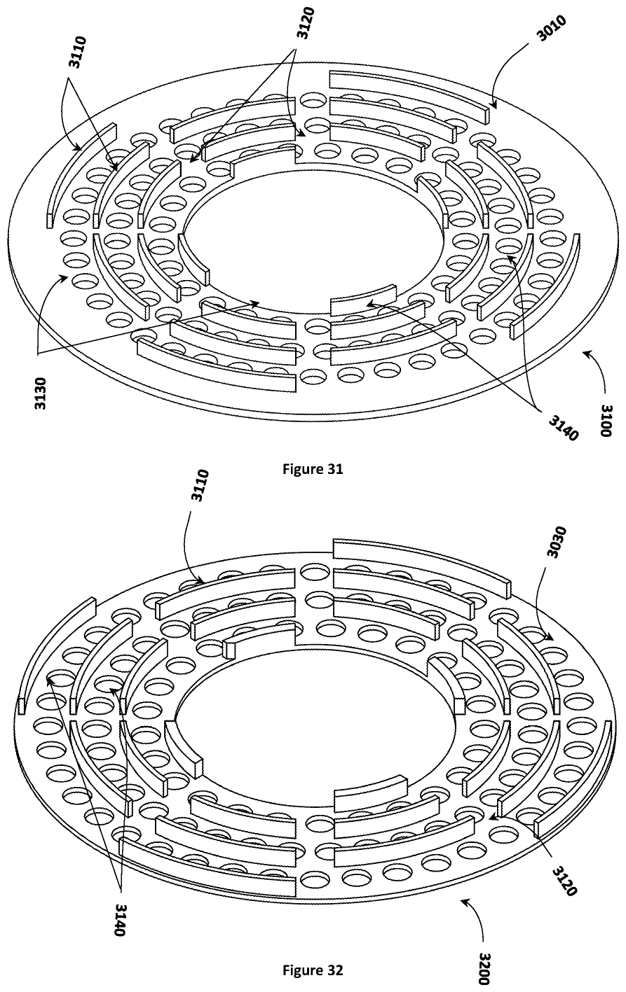

FIG. 31 depicts the perspective bottom view 3100 of the top perforated layer 3010 of the aero rooter 100 that comprised of a plurality of protrusions 3110, a plurality of narrow openings 3120, a plurality of wider openings 3130 on the outer and the inner edge protrusions 3110 to configure wider openings 3130 in the sides of the perforated air cushions 110/130, which may help penetrate the air and the plant roots into a plurality of air channels 3140 that facilitate the air pruning of roots and improvement of partial root growth. Further, the protrusion 3110 may configure with discontinuations to configure the plurality of narrow openings 3120 configured vertically, which opens through both the top and the bottom surface for roots to penetrate through the embodiment for absorption of nutrients that leads to air pruning of roots to prevent apical dominance, and to improve oxygen supply, which further improves the partial root growth.

FIG. 32 further depicts the perspective bottom view 3200 of the perforated layer 3020 of the acro rooter 100 without the wing 310, which also portrays the similarity and most of the previously explained components attached therein.

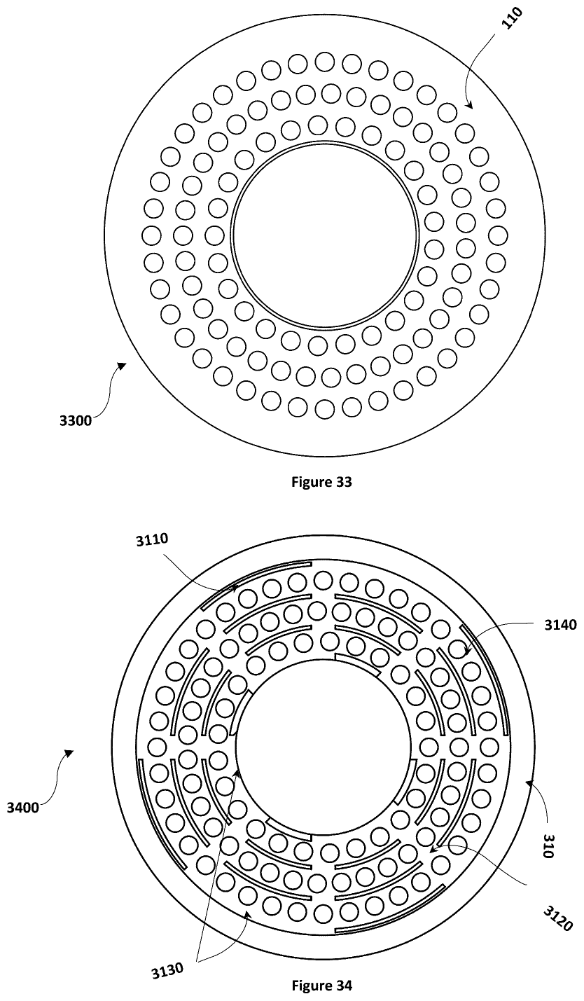

FIG. 33 depicts the plan view 3300 of the aero rooter 100 without nutrient bricks 120, or the slot openings 240 as the receptacles for the nutrient bricks 120 according to the invention. Alternatively, or in addition, the upper perforated air cushion 110 and the lower perforated air cushion 130 may configure with nutrient bricks 120 and the slot openings 240 or the receptacles, similar to the initial design I discussed.

FIG. 34 depicts the bottom view 3400 of the aero rooter 100 with the wing 310 to configure the empty space around the air channels 3140, which further illustrates the plurality of protrusions 3110, the plurality of narrow openings 3120, the plurality of wider openings 3130 on the outer and the inner edge protrusions 3110, and the air channels 3140 according to the invention.

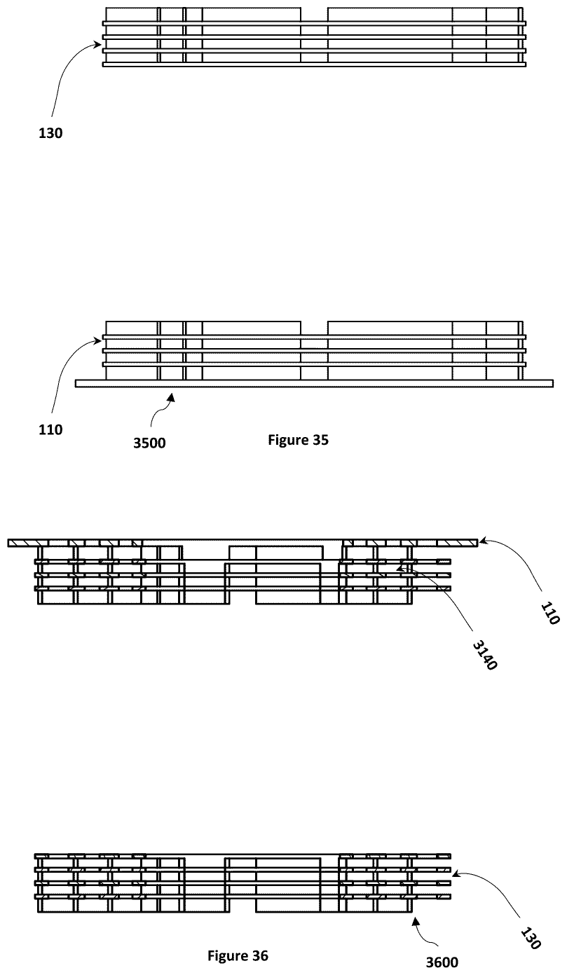

FIG. 35, the side view 3500, and FIG. 36 the sectional view 3600 of the aero rooter 100 of the given example further illustrate the protrusion 3110 stacked one under another, which may also help to combine the upper perforated layers from 3010-3040, and the lower perforated layers from 3050-3080, one under another with any generally available means for stronger connectivity of the perforated layers of the perforated air cushions 110/130 of the aero rooter 100. FIG. 36, further illustrates the cross-sectional view of the air channel 3140, after the perforated layers were bonded together to configure the upper perforated air cushion 110, and the lower perforated air cushion 130 according to the present invention.

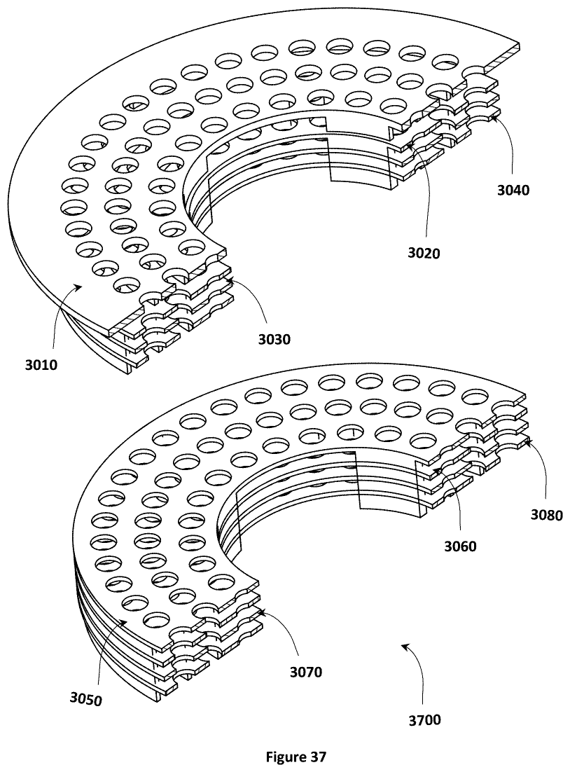

FIG. 37, the perspective front view of a cross-section 3700 depicts the aero rooter 100 with the wing 310 to configure the empty space around the air channels 3140, according to the invention.

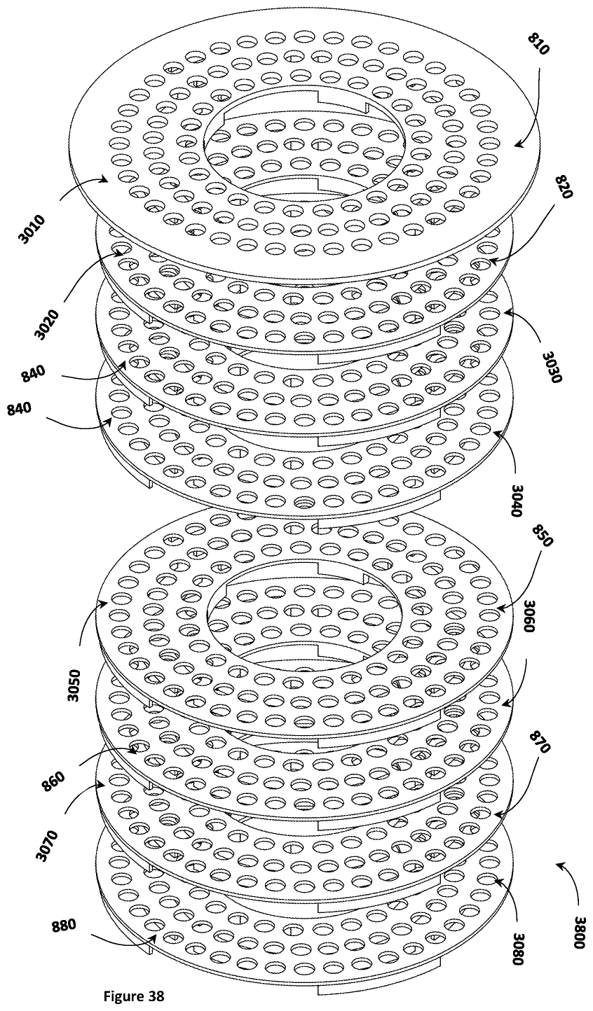

FIG. 38 depicts the exploded view 3800 of an aero rooter 100, wherein the exploded view 3800 further illustrates the external appearance of the upper perforated air cushion 110, and the lower perforated air cushion 130 without nutrient bricks 120, or the plurality of slot openings 240, in a segmented view from top to the bottom in several layers that illustrate all the previously described embodiments therein. Preferably, the given example is provided as an alternative to the nutrient bricks 120, where the same fertilizer chemical compounds used in the previous example design (design II) to spray on the surfaces may be applied using the same process on both sides of the perforated layers from 3010 to 3080 as thin layers, or alternatively embedded with raw materials as previously explained with perforated air cushions 110/130 and nutrient bricks 120, to manufacture the perforated layer 3010/3020, which may dry using an oven and seal the surface with EVA copolymer emulsion layer or alternatively, a suitable control-release chemical layer sufficient to control the period of time designed for the release based on the specific plant requirements. Alternatively, or in addition, the upper perforated air cushions 110 and the lower perforated air cushion 130 may be manufactured with nutrient bricks 120 and follow the same descriptions as of the initial design example (design I).

In further preferred embodiments, the upper perforated air cushion 110 of the aero rooter 100 may be configured with the plurality of perforated layers that are almost similar to each other as previously explained, except the wing 310 of the top perforated layer 3010, whereas each perforated layer may configure with at least one specific chemical compound attached by any appropriate means, where given example comprised of the water-soluble Sodium Molybdate [Na₂MoO₄] represent by (Mo) 810 embedded in the layer 3010, Boric Acid [H₃BO₃] represent by (B) 820 embedded in the layer 3020, Ferrous Sulfate [FeSO₄] represent by (Fe) 830 embedded in the layer 3030, Magnesium Nitrate [Mg(NO₃)₂] represent by (Mg) 840 embedded in the layer 3040 as in the previous design examples.

Preferably, the lower perforated air cushion 130 of the aero rooter 100 is also configured similarly to the upper perforated air cushion 110, without the plurality of nutrient brick 120 as of the previous example with at least one specific chemical compound embedded or sprayed, wherein given example comprised of the water-soluble Manganese Sulfate [MnSO₄] represent by (Mn) 850 embedded in the layer 3050, Zinc Sulfate [ZnSO₄] represent by (Zn) 860 embedded in the layer 3060, Copper Sulfate [CuSO₄] represent by (Cu) 870 embedded in the layer 3070, Calcium Chloride [CaCl₂)] represent by (Ca) 880 embedded in the layer 3080. Further, Chlorine (Cl) and sulfur(S) are provided with given chemical compounds, whereas given chemicals, or their individual contributions may not limit the scope of the invention as any commercially available secondary or micro required chemical compounds that are used as fertilizer formulas can be used as an alternative, or in addition, to reduce the chemical interreactions that may be taken place once dissolve in the water.

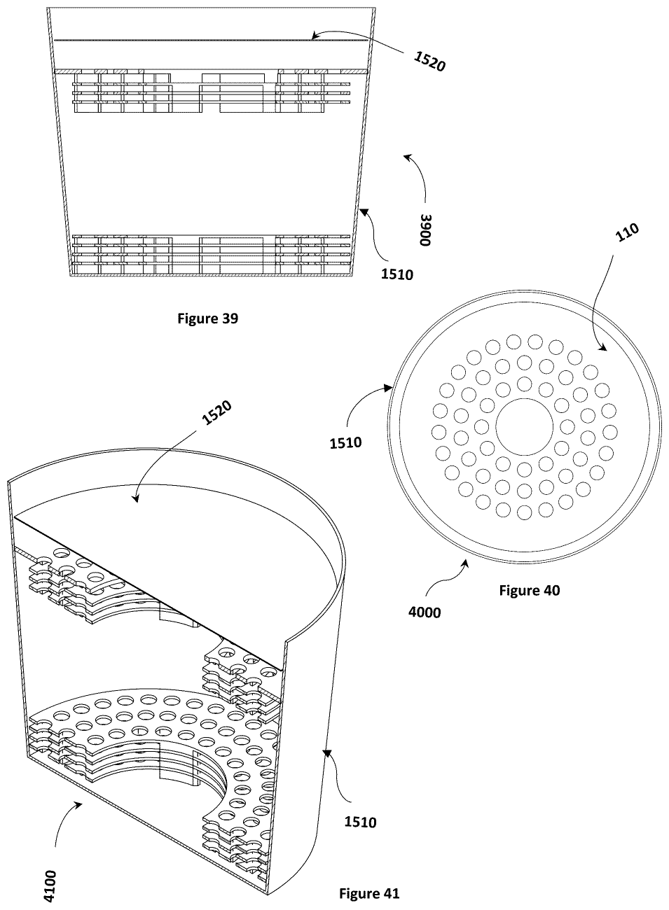

FIG. 39, FIG. 40, and FIG. 41 depict the sectional view 3900, the plan view 4000, and the sectional perspective front view 4100 of the alternative example of acro rooter 100 assembly (design III) deposited inside the plant pot 1510 below the substrate level 1520 with the upper perforated air cushion 110, and the lower perforated air cushion 130 according to the present invention. FIG. 39 further portrays how various components of the provided embodiments may fit together within the plant pot 1510 under the substrate level 1520 characterized by the deposited upper perforated air cushion 110 and the lower perforated air cushion 130, which may be embedded, or sprayed with the same chemical compounds explained previously as of the given examples. FIG. 40 portrays the plan view without the substrate inside the plant pot 1510 for visibility. As FIG. 41 further depicts, the lower perforated air cushion 130 may act as a water reservoir when the plant pot 1510 is flooded during the watering, where drained water can be collected inside empty air channels 430 and used back without wasting, while it may also act as an aeration device for the substrate and roots therein.

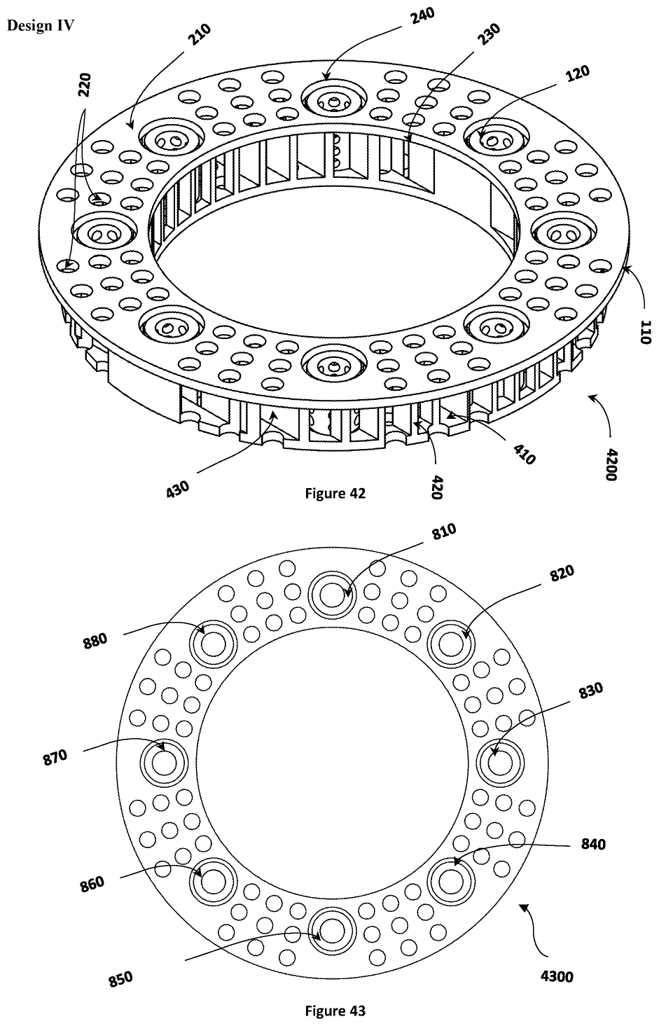

FIG. 42, depicts a perspective front view 4200 of another example alternative design of the acro rooter 100 (design IV), characterized by at least one perforated air cushion 110, with at least one nutrient brick 120, configured to represent different plant nutrients including macro or micro category fertilizers to be used in horticulture according to the invention. Preferably, the upper perforated air cushion 110 comprised of the top surface 210, the plurality of apertures 220 for the porosity of the upper perforated air cushion 110, the slot opening 230, the plurality of slot openings 240 as receptacles for the nutrient bricks 120, the internal surface 410, the protrusion 420, and the air channels 430 of the upper perforated air cushion 110.

FIG. 43 depicts the plan view 4300 of an aero rooter 100, which may represent the upper perforated air cushion 110 as a single embodiment to deliver the required nutrients. In a further preferred embodiment, the aero rooter 100 comprises of the plurality of nutrient bricks 120 that may represent all the secondary and micro required fertilizers for plant growth. Each nutrient brick 120 may represent with at least one specific chemical compound attached by any appropriate means, where the given example comprised of the water-soluble Sodium Molybdate [Na₂MoO₄] represented by (Mo) 810, Boric Acid [H₃BO₃] represent by (B) 820, Ferrous Sulfate [FeSO₄] represent by (Fe) 830, Magnesium Nitrate [Mg(NO₃)₂] represent by (Mg) 840, Manganese Sulfate [MnSO₄] represent by (Mn) 850, Zinc Sulfate [ZnSO₄] represent by (Zn) 860, Copper Sulfate [CuSO₄] represent by (Cu) 870, and Calcium Chloride [CaCl₂)] represent by (Ca) 880. Further, the chlorine (Cl) and the sulfur(S) are provided with given chemical compounds, whereas given chemicals or their individual contributions may not limit the scope of the invention as any commercially available secondary, or micro required fertilizer chemical compounds that are used as fertilizer formulas can be used as an alternative, or in addition, to reduce the chemical interreactions that may be taken place once dissolve in the water. In a further preferred embodiment, the slot opening 240 may penetrate the bottom surface 330 with the smaller aperture 220 as portrayed in FIG. 44 to support the holding of the nutrient brick 120, which may further help to prevent or minimize chemical interreactions when it leaches to the substrate as chemical descend downward without interactions from nearby chemical compounds.

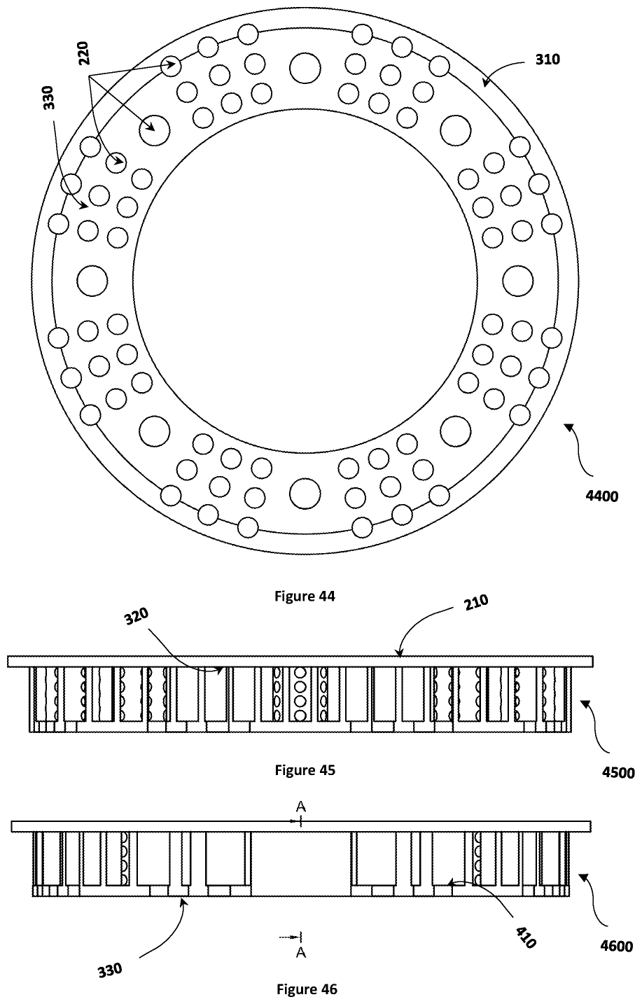

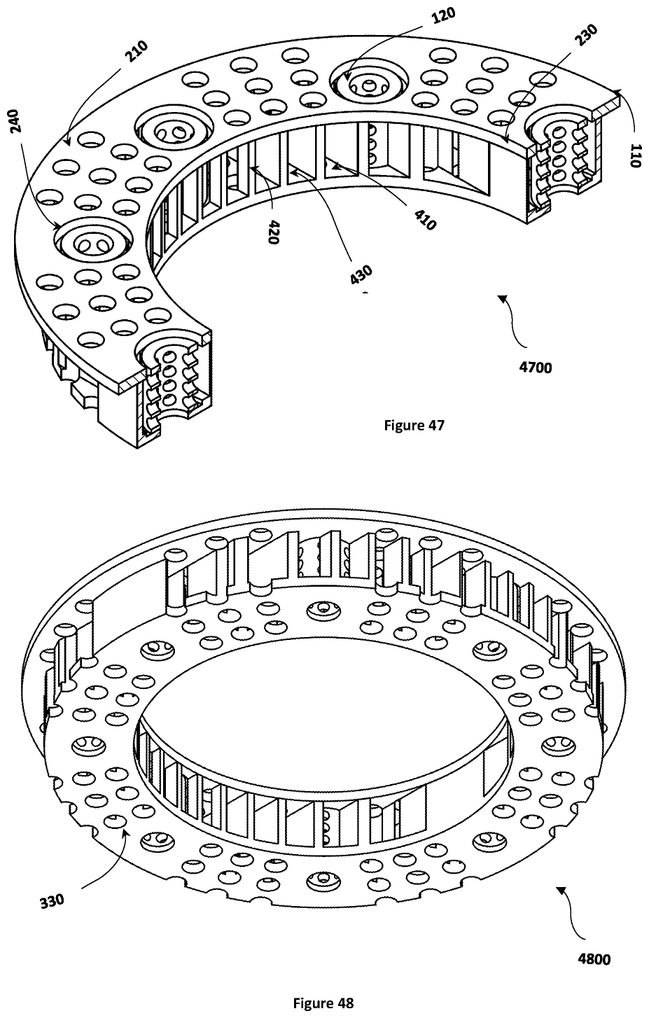

FIG. 44, FIG. 45, FIG. 46, FIG. 47, and FIG. 48 depict the bottom view 4400, the front view 4500, the side view 4600, the sectional perspective front view 4700, and the perspective bottom view 4800 of the example aero rooter 100 assembly according to the invention. Preferably, the upper perforated air cushion 110 may characterize by the wing 310 with the under surface 320, which may be an outward extension of the top surface 210 to create the empty space connecting all air pockets to the external air movement through cracks between the substrate and the sidewall of the plant pot 1510. In a further preferred embodiment, the upper perforated air cushion 110 comprised of the bottom surface 330 with the plurality of apertures 220 for the porosity of the bottom surface 330, the internal surface 410 with the protrusion 420, and the air channels 430 of the upper perforated air cushion 110, and the slot opening 230 that may cut through whole embodiment connecting the over and under substrate layers for improved plant growth.

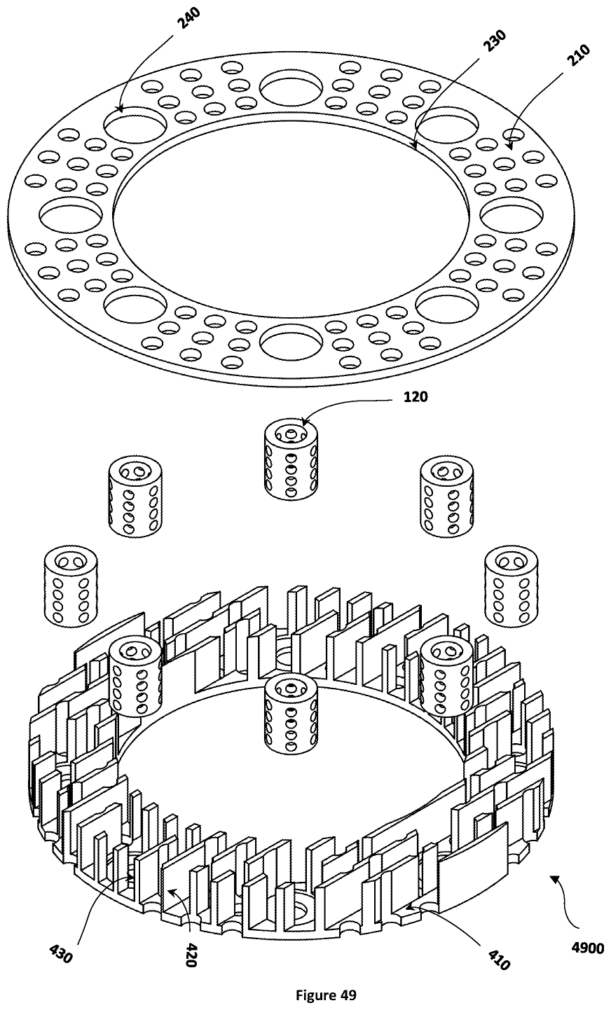

FIG. 49 depicts the exploded view 4900 of the aero rooter 100, wherein the exploded view 4900 further illustrates the internal and external views of the upper perforated air cushion 110, the nutrient bricks 120, the internal surface 410, the protrusion 420, and the air channels 430 in a segmented view from top to the bottom in three layers and the structure inside with all the previously described embodiments therein.

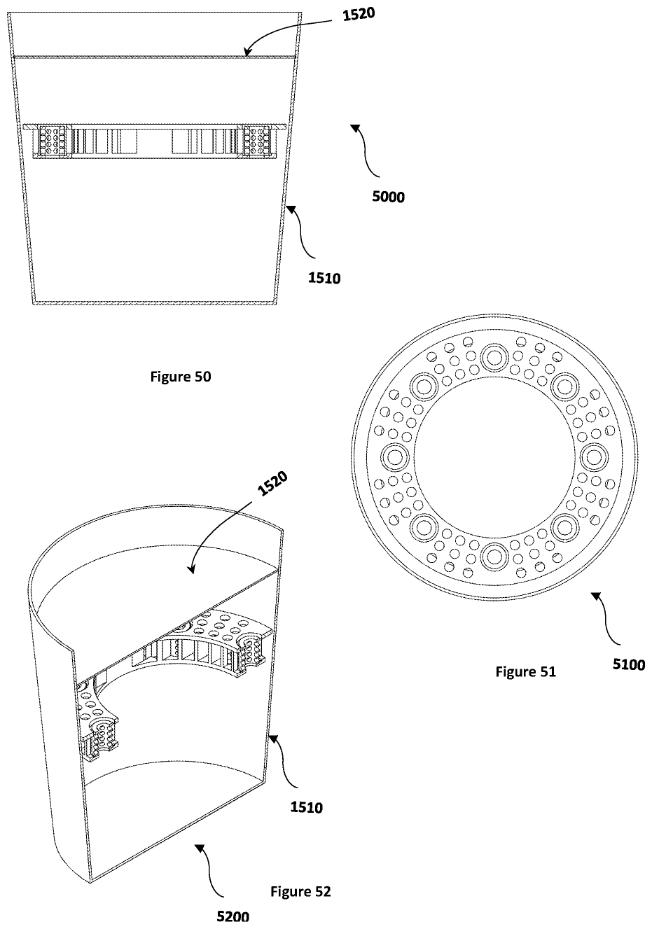

FIG. 50, FIG. 51, and FIG. 52 depict the sectional view 5000, the plan view 5100, and the sectional perspective front view 5200 of the given example acro rooter 100 assembly (design IV) deposited inside the plant pot 1510 below the substrate level 1520 with the upper perforated air cushion 110, and the nutrient bricks 120 according to the present invention. FIG. 51 portrays the plan view without the substrate 1520 inside the plant pot 1510 for visibility. As FIG. 52 further depicts, the aero rooter 100 of the given example may comprise only the upper perforated air cushion 110, whereas any lower perforated air cushion 130 of the previously explained designs (design I, II, and III) may alternatively use without any nutrient bricks 120, or fertilizer chemical compounds sprayed, or embedded on it as the lower perforated air cushion 130, which may act as a water reservoir when the plant pot 1510 is flooded during the watering, where drained water can be collected inside empty air channels 430 and used back without wasting, while it may also act as air pruning and aeration device for the substrate and the roots therein.

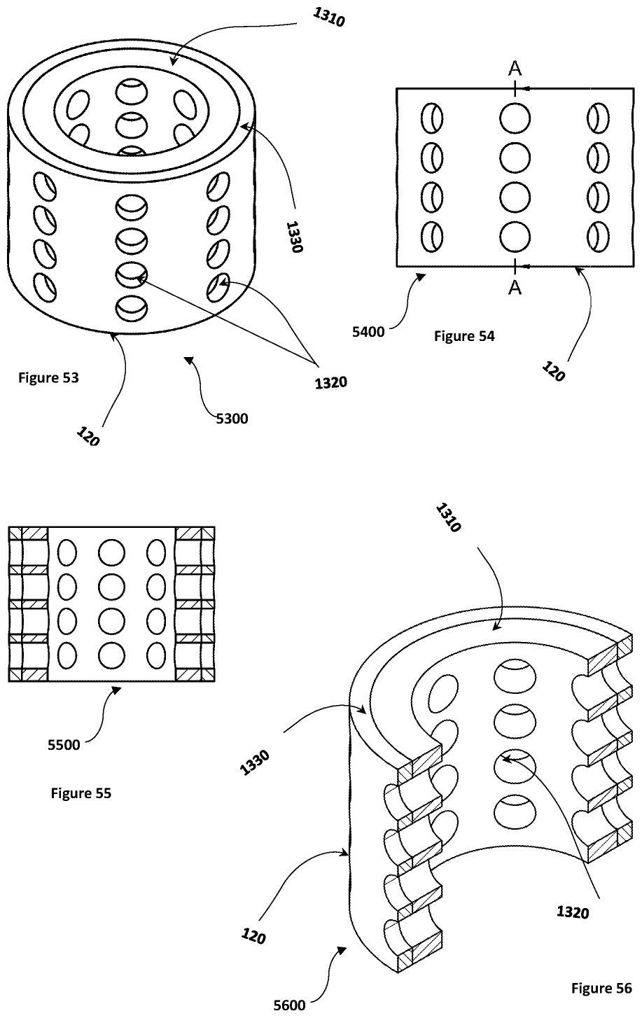

FIG. 53, FIG. 54, FIG. 55, and FIG. 56 depict the perspective front view of 5300, the front view of 5400, the cross-sectional view of 5500, and the perspective front view of the cross-section 5600 of a cylindrically configured nutrient brick 120, with various components therein explained previously in FIG. 12, and FIG. 13 according to the present invention. In a further preferred embodiment, FIG. 53 depicts the perspective front view of the hollow nutrient brick 120 that comprised of the hollow core 1310, the plurality of apertures 1320 spread around the hollow core 1310, and the barrier film 1330 to cover up the nutrient brick 120, which control-release the specific fertilizer variety embedded within the hollow core 1310 of the nutrient brick 120, during a 3-4 month growing season, or after the field planting with perineal plants.

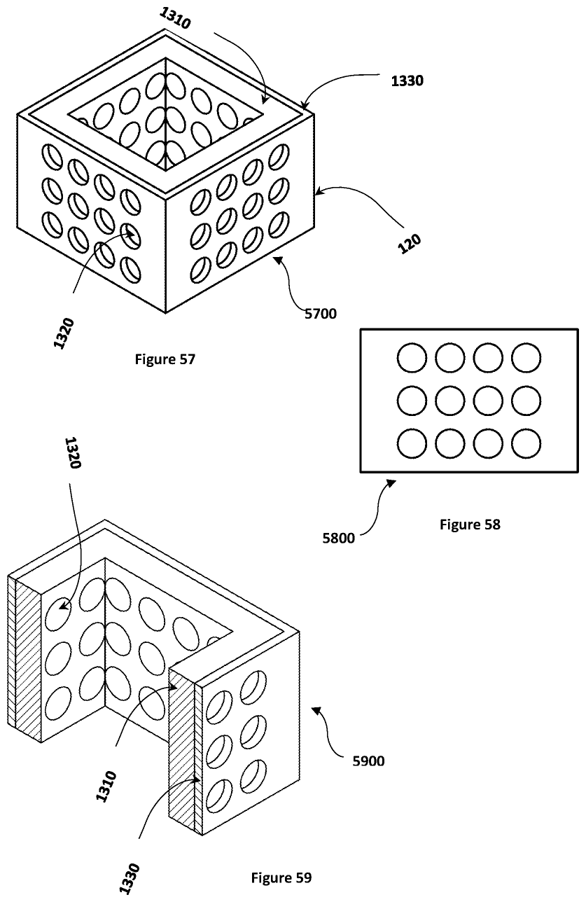

FIG. 57, FIG. 58, and FIG. 59 depict the perspective front view of 5700, the front view of 5800, and the perspective front view of the cross-section 5900 of a rectangularly configured nutrient brick 120, with various components therein explained previously, according to the invention. The nutrient brick 120 may configure with any convenient shape, or design according to the specific use and the preference of the manufacturer without deviating from the scope. Preferably, the nutrient brick 120 may be modified to ventilate the substrate as well as to deliver secondary and micro required fertilizer, which may partially support air pruning of the roots, according to the present invention. In a further preferred embodiment, the nutrient brick 120 may not only represent using the hollow rectangular and the hollow cylindrical shapes, where the scope will include all such modifications with any changes to the shape or the size without changing the core objectivity of delivering macro and micro required fertilizer varieties to the plants.

FIG. 60, FIG. 61, and FIG. 62 depict the plan view of 6000, the perspective front view of 6100, and the perspective bottom view of 6200 of an alternatively configured nutrient platelet 6000, using similar components previously explained with various designs according to the invention. Preferably, the nutrient platelet 6000 is alternatively configured to function as a nutrient brick 120 to deliver secondary and micro required fertilizer, as well as to ventilate the substrate and promote partial air pruning of the plant roots, according to the present invention. In further preferred embodiments FIGS. 60, 61, and 62 further illustrate the nutrient platelet 6000 comprised of the plurality of apertures 1320 spread around the nutrient platelet 6000 characterized by the wing 6010 similar to the wing 310, the plurality of protrusions 3110 on the vertical plane configuring the plurality of air channels 3140 with the plurality of apertures 1320 spread around horizontally on the protrusion 3110, and with, or without the barrier film 1330 to cover up the nutrient platelet 6000, which control-release the specific fertilizer varieties embedded within the hollow core 1310 of the nutrient platelet 6000, during a 3-4 month growing season, or after the field planting with perineal plants. Further, the plurality of apertures 1320 spread around helps penetrate the air and the plant roots into the plurality of air channels 3140 that facilitate the air pruning of roots and improvement of partial root growth. Alternatively, or in addition, two or more of the nutrient platelets 6000, may combine together by any appropriate means with compatible nutrient platelets 6000 for the deposition inside the plant pot 1510 while planting or transplanting according to the present invention.

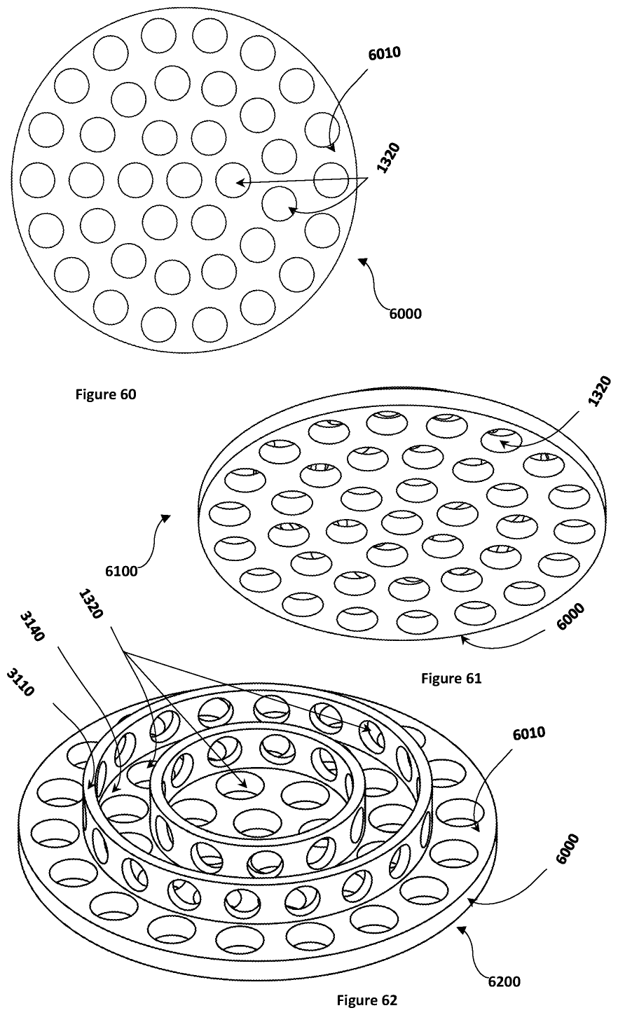

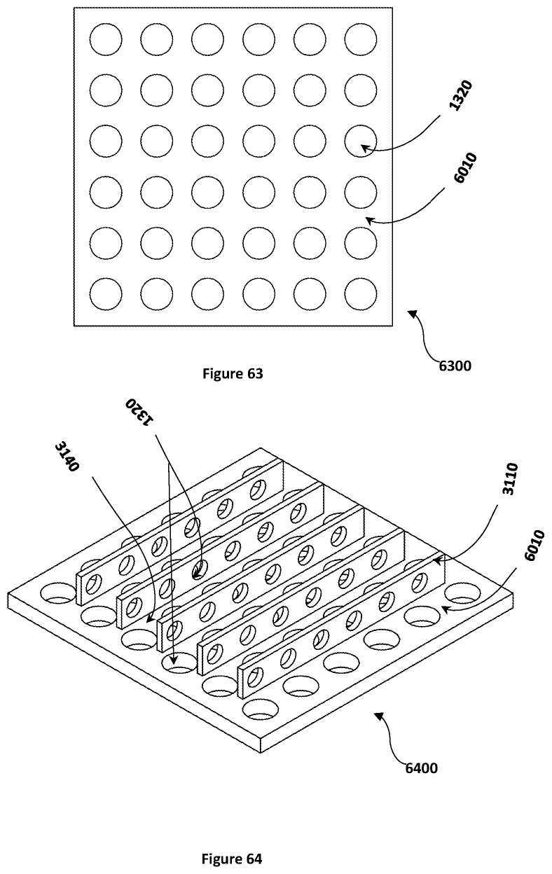

FIG. 63, and FIG. 64 depict the plan view of 6300, and the perspective bottom view 6400 of an alternatively configured nutrient platelet 6000, with similar components previously explained with various designs according to the invention. Preferably, the nutrient platelet 6000 of FIG. 63 is an alternatively configured nutrient platelet 6000 to deliver secondary and micro required fertilizer, as well as to ventilate the substrate and provide partial air pruning to the plant roots, as previously explained in FIG. 60, FIG. 61 and FIG. 62. In further preferred embodiments, FIGS. 63 and 64 further illustrate the nutrient platelet 6000 comprised of the plurality of apertures 1320 spread around the nutrient platelet 6000 characterized by the wing 6010, the plurality of protrusions 3110 configuring the plurality of air channels 3140 with the plurality of apertures 1320 spread around horizontally on the protrusion 3110, and with or without the barrier film 1330 to cover up the nutrient platelet 6000, which control-release the specific fertilizer variety embedded within the hollow core 1310 of the nutrient platelet 6000, during a 3-4 month growing season, or after the field planting with perineal plants.

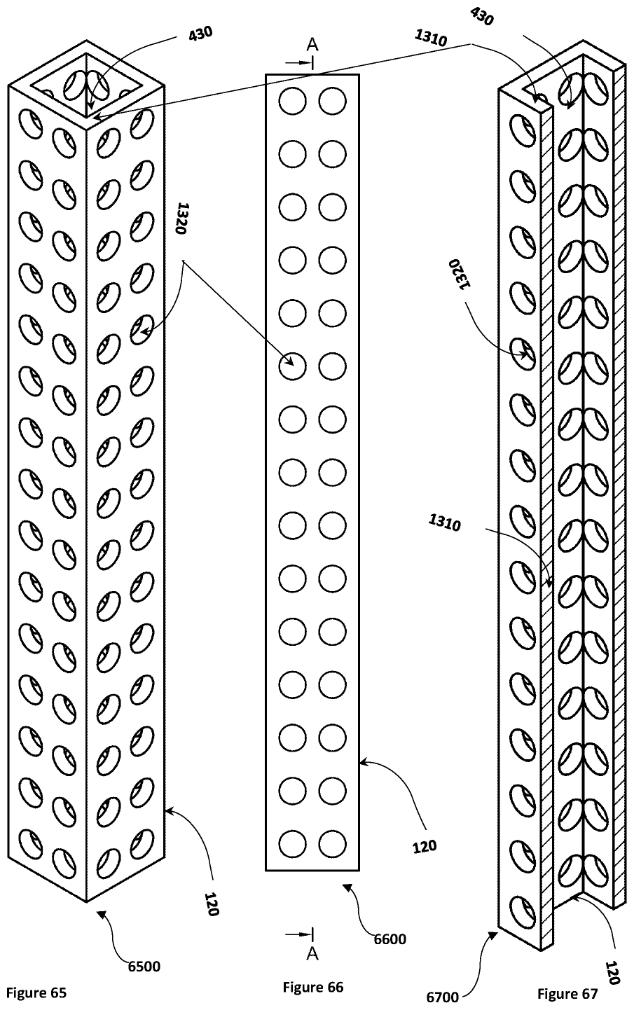

FIG. 65, FIG. 66, and FIG. 67 depict the perspective front view of 6500, the front view 6600, and the perspective front view of the cross-section 6700 of an alternatively configured rectangular shaped nutrient brick 120, with various components therein explained previously according to the invention. The nutrient brick 120 is configured as an elongated hollow tube 6500 to use as an alternative air channel 430, on a horizontal or vertical plane or in an angle with the plurality of apertures 1320 around the hollow core 1310 for the porosity, and with or without the barrier film 1330 to cover up the elongated hollow tube 6500 for the control-release of fertilizer variety embedded within the elongated hollow tube 6500, which control-release the specific fertilizer variety embedded within the hollow core 1310 of the elongated hollow tube 6500, during a 3-4 month growing season, or after the field planting with perineal plants. The nutrient brick 120 may configure with any convenient shape or design according to the specific use and the preference of the manufacturer without deviating from the scope. Preferably, the nutrient brick 120 may be modified to deliver secondary and micro required fertilizer, as well as to ventilate the substrate, which may partially support air pruning of the roots, according to the present invention.

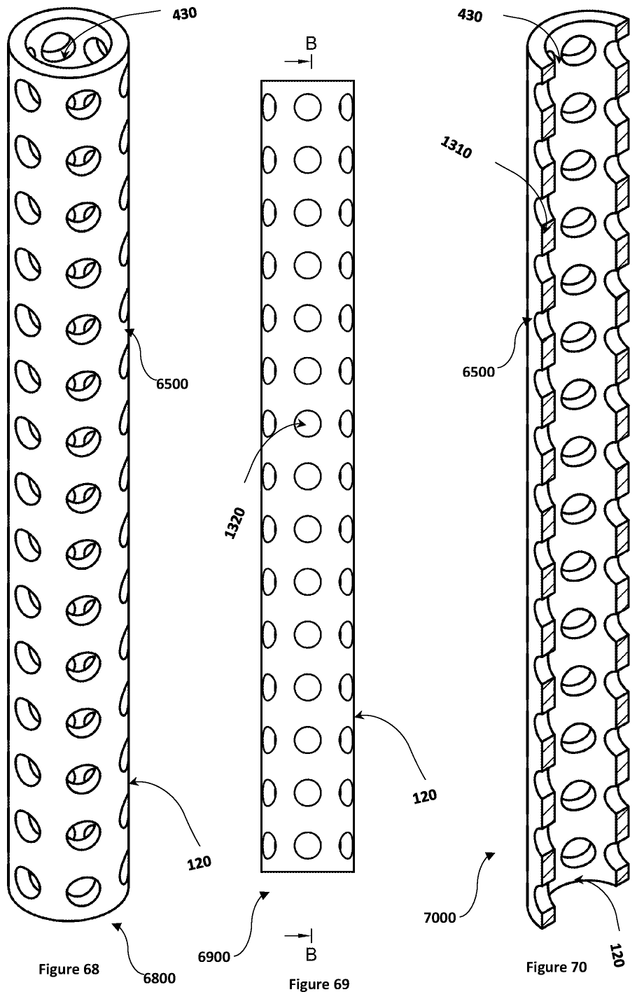

FIG. 68, FIG. 69, and FIG. 70 depict the perspective front view of 6800, the front view of 6900, and the perspective front view of the cross-section 7000 of an alternatively configured cylindrical shaped nutrient brick 120, with various components therein explained previously according to the invention. In a further preferred embodiment, the nutrient brick 120 may not only represent using the hollow rectangular and the hollow cylindrical shapes, where the scope will include all such modifications with any changes to the shape or the size without changing the core objectivity of delivering macro and micro required fertilizer varieties to the plants, or ventilate the substrate, or both.

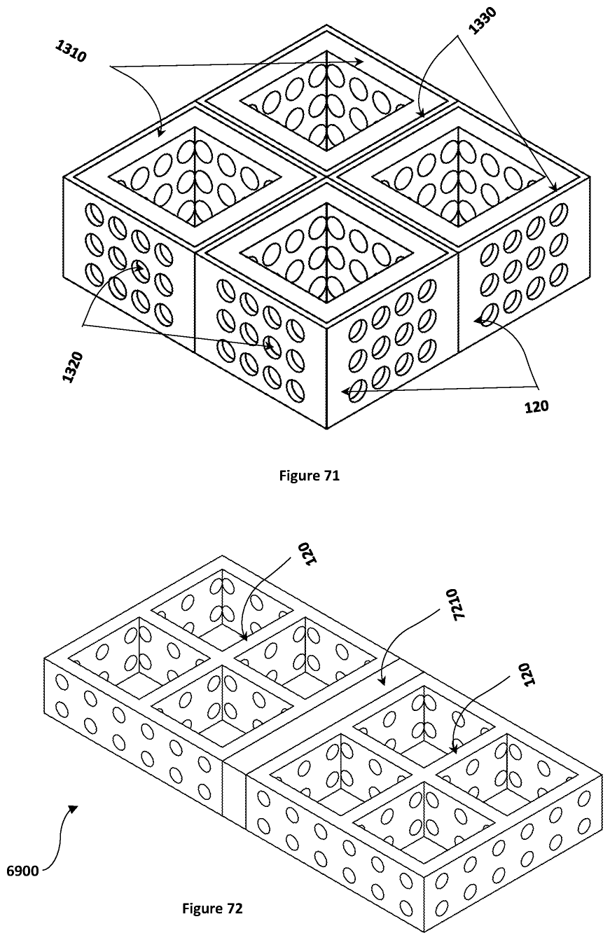

FIG. 71, and FIG. 72 depict the perspective front view of 7100, and the perspective front view 7200 of an alternatively configured rectangular shaped plurality of nutrient bricks 120, combined as a single embodiment for the case of use in the field or plant pots with various components therein explained previously according to the invention. In further preferred embodiments, the nutrient brick 120 may configure to combine together two or more of the nutrient brick 120 by any appropriate means with or without a separator 7210 and the barrier film 1330, which control-release the specific fertilizer variety embedded within the hollow core 1310 of the nutrient brick 120, during a 3-4 month growing season, or after the field planting with perineal plants. Further, the separator 7210 may configure with the same materials as of the nutrient brick 120, but they do not have any chemicals embedded within, where the separator 7210 is used to provide separation of chemical compounds to reduce interreactions while releasing to the medium and before absorption to the plant roots.

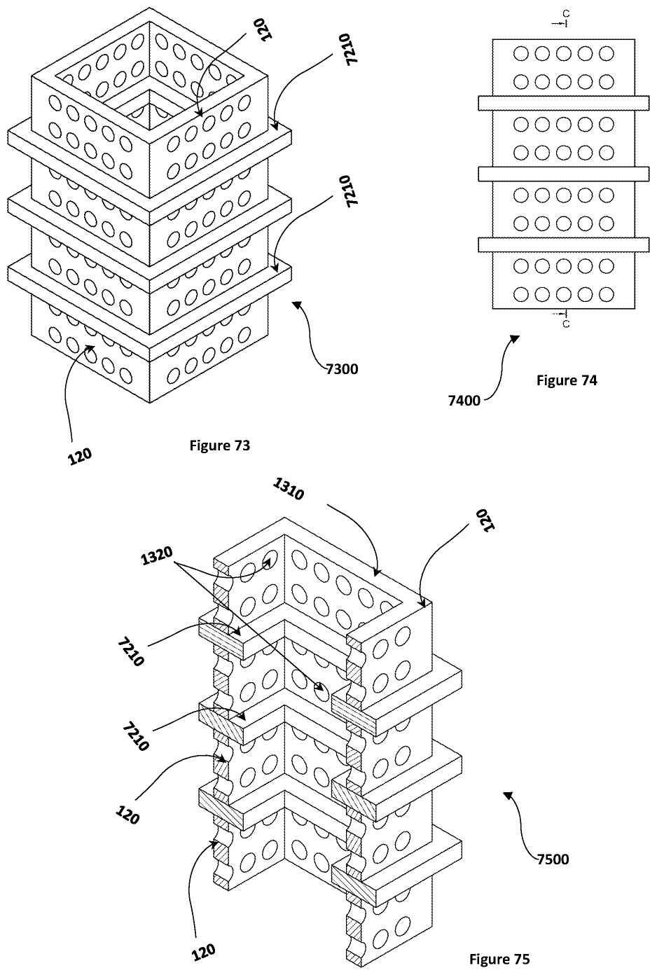

FIG. 73, FIG. 74, and FIG. 75 depict the perspective front view of 7300, the front view of 7400, and the perspective front view of the cross-section 7500 of an alternatively configured plurality of rectangular shaped nutrient brick 120, separated by the plurality of separators 7210, as a group of multi-nutrient bricks 7300 with various components therein explained previously according to the invention. The nutrient bricks 120 characterized by different fertilizer supplements that may configure to combine together with two or more nutrient bricks 120 by any appropriate means with or without a separator 7210 and with or without the barrier film 1330, as the group of multi-nutrient bricks 7300 that represents various compatible secondary and micro required fertilizer varieties for the control-release of different fertilizer varieties embedded within the nutrient bricks 120. The nutrient bricks 120, may represent the plurality of apertures 1320 around the hollow core 1310 for the porosity, and with or without the barrier film 1330 to cover up the group of multi-nutrient bricks 7300, which control-release the specific fertilizer varieties embedded within the group of multi-nutrient bricks 7300, during a 3-4 month growing season, or after the field planting with perineal plants.

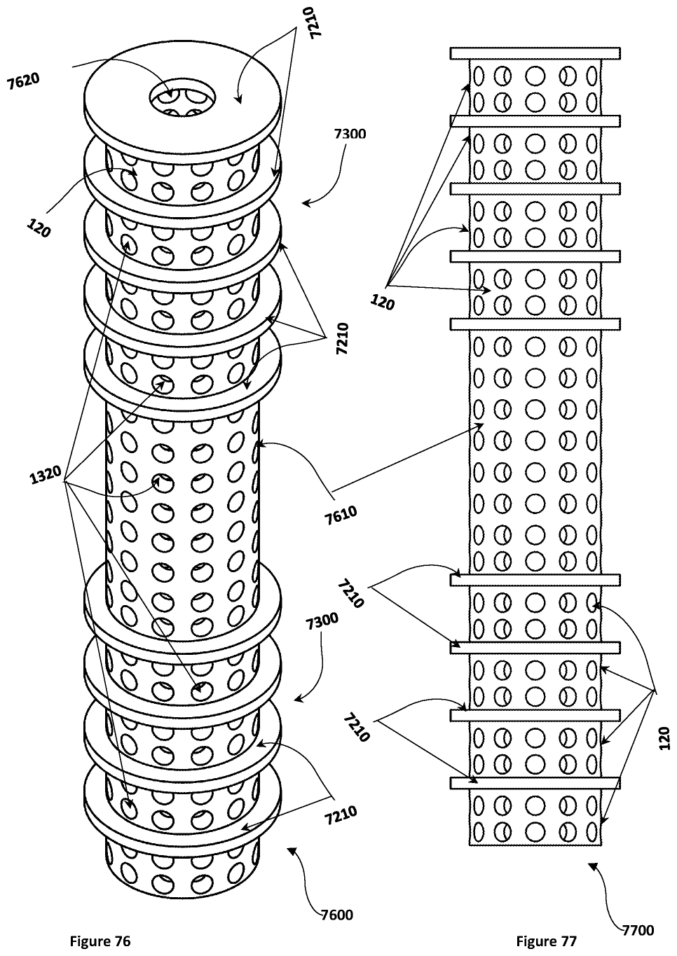

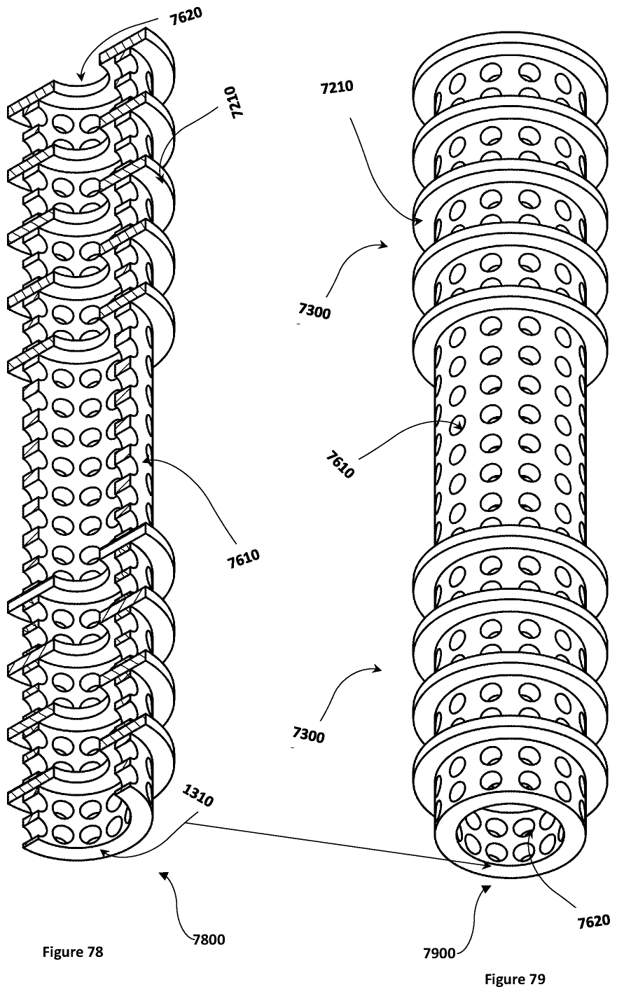

FIG. 76, FIG. 77, FIG. 78, and FIG. 79 depict the perspective front view 7600, the front view 7700, the perspective front view of the cross-section 7800 in the vertical plane, and the perspective bottom view 7900 of an alternatively configured multi-nutrient brick air channel 7600 characterized by the plurality of nutrient bricks 120, separated by the plurality of separators 7210, and at least one long hollow brick 7610 (another type of separator) with various components therein explained previously according to the invention. The long hollow brick 7610 may also configure in the same method described as of the separator 7210, and configured to increase the distance between the upper group of multi-nutrient bricks 7300 and the lower group of multi-nutrient bricks 7300. The different fertilizer supplement added nutrient bricks 120 may configure to combine together with two or more nutrient bricks 120 by any appropriate means with or without the separator 7210, or the barrier film 1330 that represents various compatible secondary and micro required fertilizer varieties for the control-release of different fertilizer varieties sprayed or embedded within the nutrient bricks 120. The multi-nutrient brick air channel 7600, may represent the plurality of apertures 1320 around the hollow core 1310 for the porosity, and with or without the barrier film 1330 to cover up the multi-nutrient brick air channel 7600, which control-release the specific fertilizer variety embedded within the hollow core 1310 of the nutrient brick 120, during a 3-4 month growing season, or after the field planting with perineal plants.

In a further preferred embodiment, the multi-nutrient brick air channel 7600 may be characterized by the plurality of nutrient bricks 120, the separator 7210, and the long hollow brick 7610 configured to combine together with any appropriate means to use as an alternative air channel 7620 acting similar to the air channel 430, with the plurality of apertures 1320 around the hollow core 1310 for the porosity, which may provide ventilation to the substrate by connecting outside air through the air channel 7620 with or without the barrier film 1330.

FIG. 80 depicts the plan view 8000 of the multi-nutrient brick air channel 7600, according to the invention.

FIG. 81 depicts the bottom view 8100 of the multi-nutrient brick air channel 7600, according to the invention.

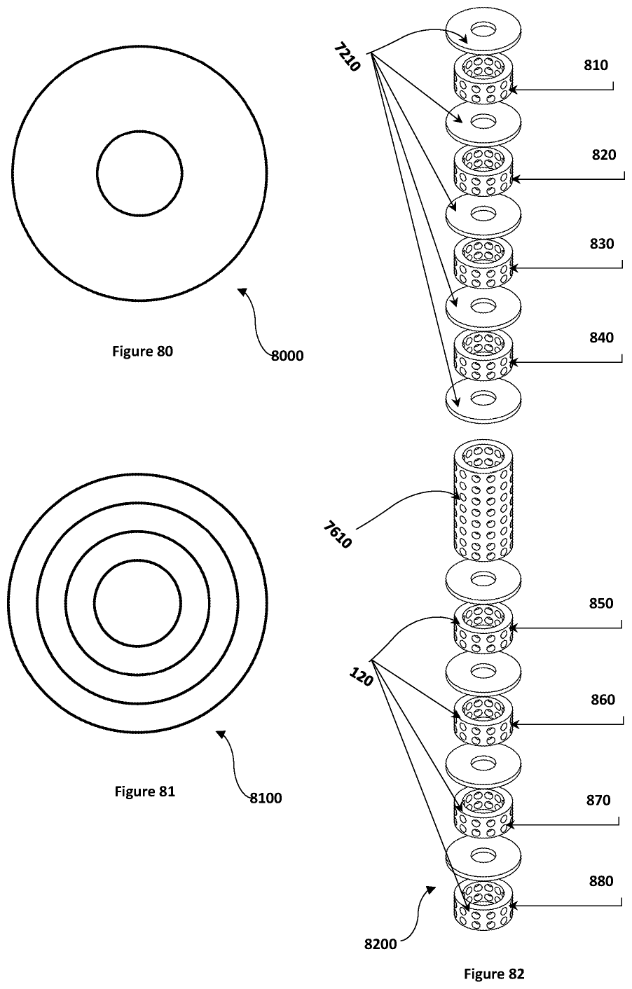

FIG. 82 depicts the exploded view 8200 of the multi-nutrient brick air channel 7600, wherein the exploded view 8200 further depicts the internal and external views of the upper group of multi-nutrient bricks 7300 and the lower group of multi-nutrient bricks 7300, in a segmented view from top to the bottom in several layers that illustrate the structure inside with all the previously described embodiments therein. In a further preferred embodiment, the multi-nutrient brick air channel 7600 comprises of the plurality of nutrient brick 120 that may represent all the micro and secondary fertilizers required for plant growth. Each nutrient brick 120 may represent at least one specific chemical compound attached by any appropriate means, wherein the given example comprised of the water-soluble Sodium Molybdate [Na₂MoO₄] represent by (Mo) 810, Boric Acid [H₃BO₃] represent by (B) 820, Ferrous Sulfate [FeSO₄] represent by (Fc) 830, Magnesium Nitrate [Mg(NO₃)₂] represent by (Mg) 840, Manganese Sulfate [MnSO₄] represent by (Mn) 850, Zinc Sulfate [ZnSO₄] represent by (Zn) 860, Copper Sulfate [CuSO₄] represent by (Cu) 870, Calcium Chloride [CaCl₂)] represent by (Ca) 880. Further, the chlorine (Cl) and the sulfur(S) are provided with given chemical compounds, whereas given chemicals or their individual contributions may not limit the scope of the invention as any commercially available secondary or micro required chemical compounds that are used as fertilizer chemical compounds can be used as an alternative, or in addition, to reduce the chemical interreactions that may be taken place once dissolve in the water.

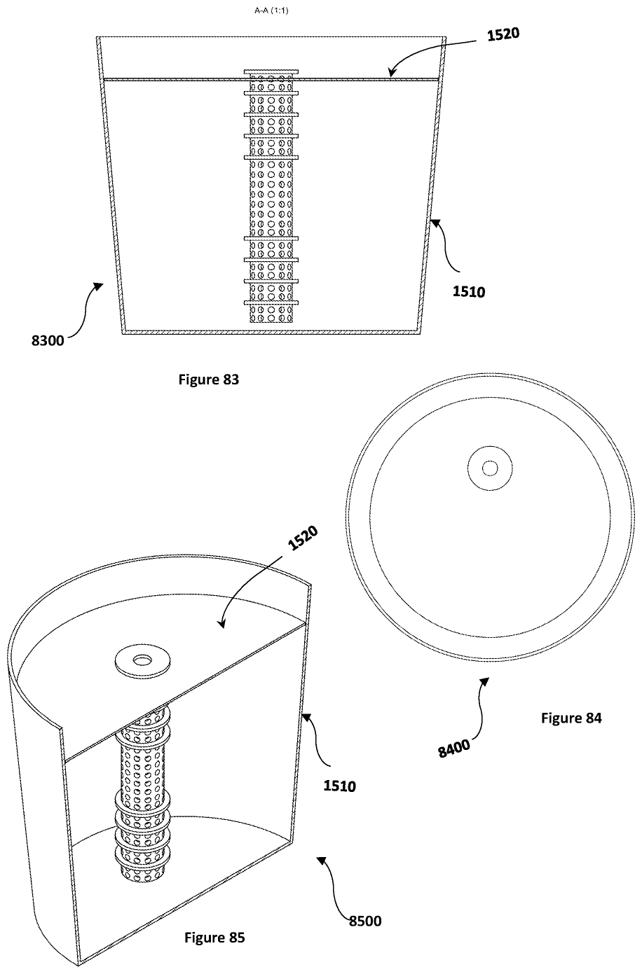

FIG. 83, FIG. 84, and FIG. 85 depict the sectional view 8300, the plan view 8400, and the sectional perspective front view 8500 of the given example multi-nutrient brick air channel 7600 deposited inside the plant pot 1510 below the substrate level 1520 with the upper group of multi-nutrient bricks 7300, the plurality of separators 7210, the long hollow brick 7610, and the lower group of multi-nutrient bricks 7300, according to the present invention. FIG. 84 portrays the plan view 8400 without the substrate 1520 inside the plant pot 1510 for visibility. As FIG. 85 further depicts, the multi-nutrient brick air channel 7600 of the example may deposit during the transplanting on a vertical plane as given or, alternatively horizontally, or at any angle keeping at least one end of an air channel 7620 open to environmental air movements, which may also act as partial air pruning and aeration device for the substrate and the roots therein.

FIG. 86, FIG. 87, and FIG. 88 depict the plan view 8600, the sectional perspective front view 8700, and the sectional view 8800, of an example method for depositing the individual nutrient brick 120 inside the plant pot 1510 without the substrate for clarity, according to the invention. FIG. 86 portrays the plan view 8600 without the substrate 1520 inside the plant pot 1510 for visibility. As FIG. 88 further depicts, the nutrient bricks 120 may organize in the single plane or as any alternative methods within the plant pot 1510 or around a transplanting tree in the field according to the invention.

Further, FIG. 89, and FIG. 90 depict the sectional perspective front view 8900 and the sectional view 9000, of an example alternative method for depositing the nutrient brick 120 inside the plant pot 1510, which may lay nutrient bricks 120 in a downward spiral as illustrated without the substrate for clarity, according to the invention.

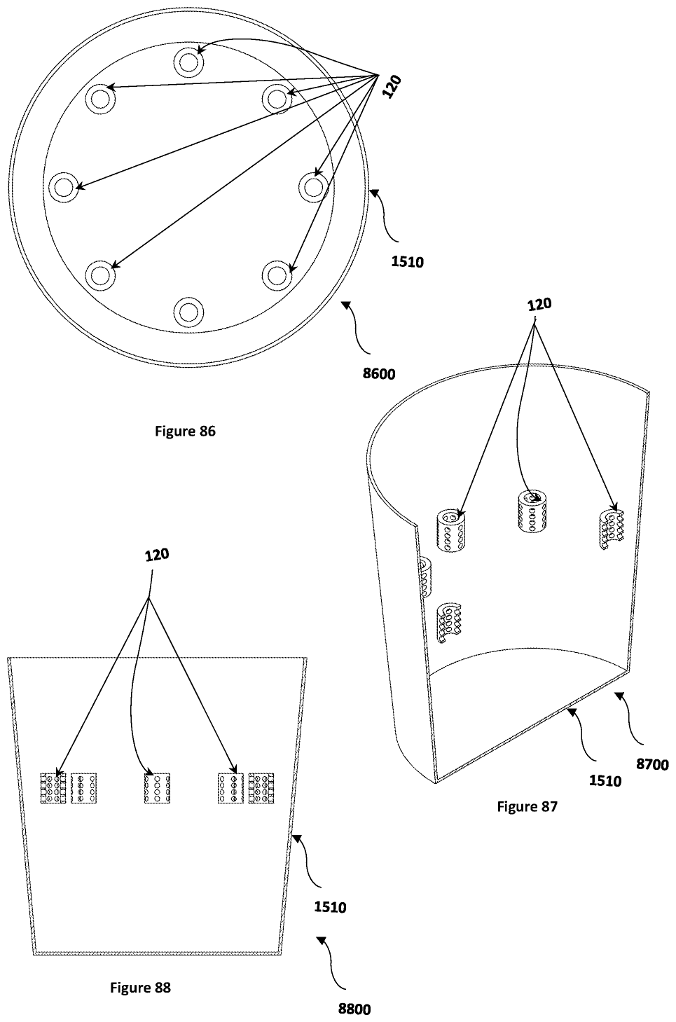

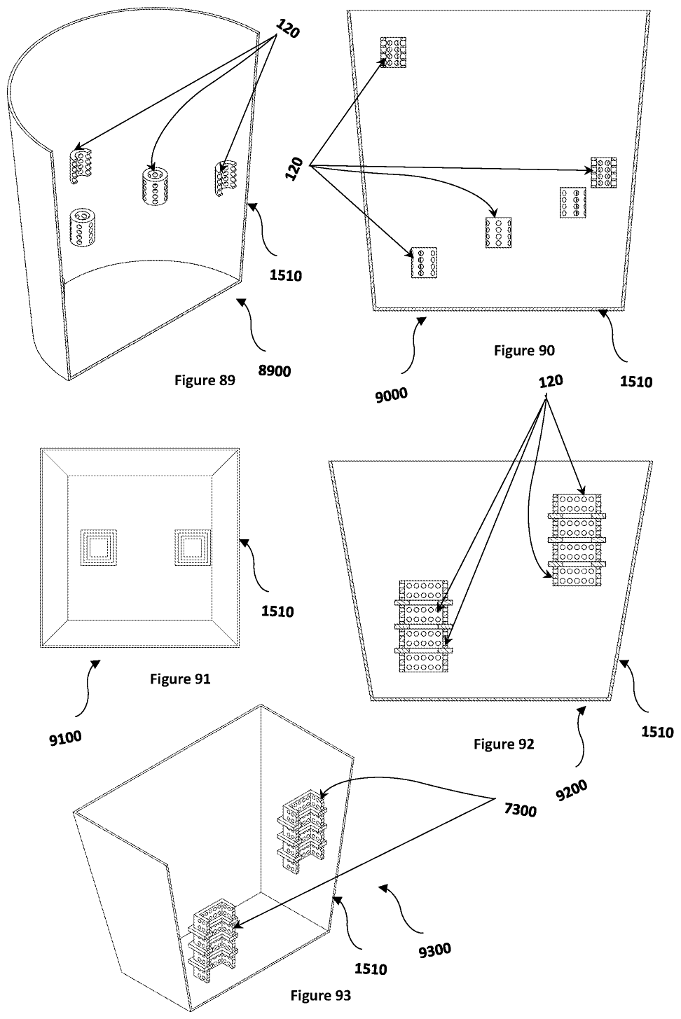

FIG. 91, FIG. 92, and FIG. 93 depict the plan view 9100, the sectional view 9200, and the sectional perspective front view 9300 of the given example group of multi-nutrient bricks 7300 deposited inside the plant pot 1510 as one or more groups of multi-nutrient bricks 7300 according to the present invention. FIG. 91 portrays the plan view without the substrate 1520 inside the plant pot 1510 for visibility. As FIG. 93 further depicts, the group of multi-nutrient bricks 7300 of the given example may comprise only fewer blocks with different compatible fertilizer formulations to reduce the additional labour required and the precision for the application of single nutrient bricks 120. Preferably, the group of multi-nutrient bricks 7300 may be deposited in two or more layers in the substrate to reduce the chemical interreactions of incompatible fertilizer varieties used in configuring nutrient bricks 120. Alternatively, or in addition to the given example, there are many other different ways of depositing the single nutrient bricks 120 or compatible multi-brick nutrition formulas inside a plant pot or in the field that are also covered in the scope of the invention.

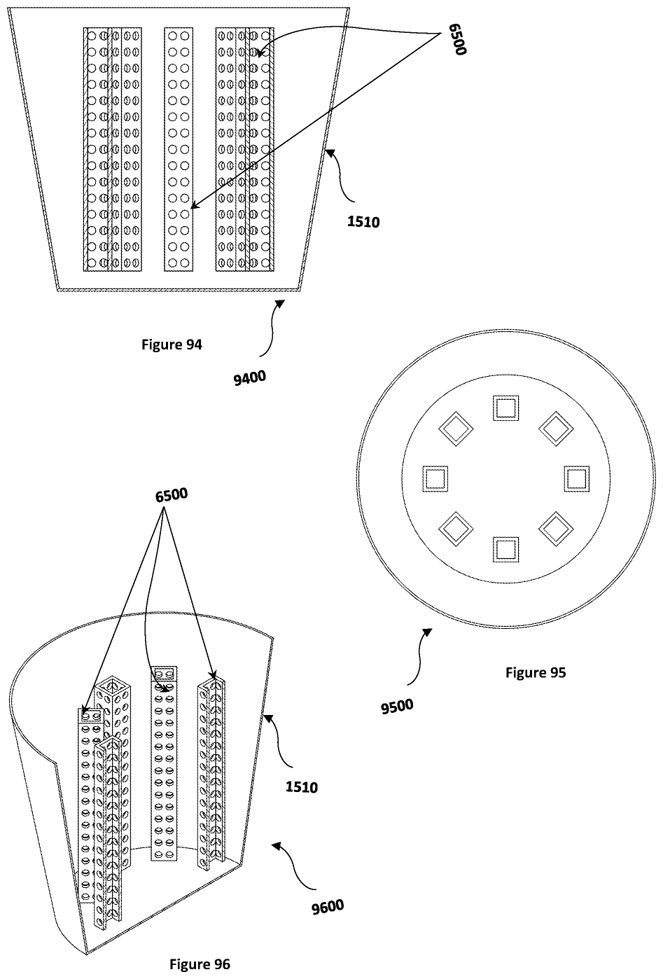

FIG. 94, FIG. 95, and FIG. 96 depict the sectional view 9400, the plan view 9500 and the sectional perspective front view 9600 of the elongated hollow tube 6500 of the given alternative example nutrient brick 120 depict the use and their alternatives, whereas the elongated hollow tube 6500 may use as a horizontal or vertical air channel, FIG. 95 portrays the plan view 9500 without the substrate 1520 inside the plant pot 1510 for visibility. As FIG. 96 further depicts, the elongated hollow tube 6500 of the example may deposit during the transplanting on a vertical plane as given or, alternatively horizontally, or at any angle keeping at least one end of the air channel 430 open to environmental air movements, which may also act as partial air pruning and aeration device for the substrate and the roots therein for the control-release of fertilizer variety embedded within the elongated hollow tube 6500, which control-release the specific fertilizer variety embedded within the hollow core 1310 of the elongated hollow tube 6500, during a 3-4 month growing season, or after the field planting with perineal plants.

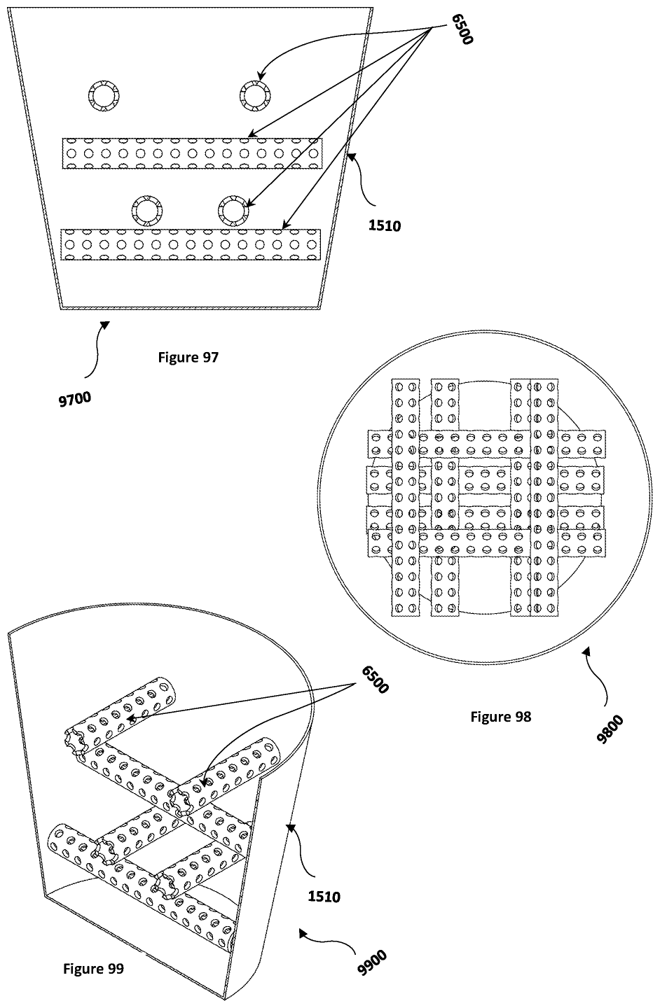

FIG. 97, FIG. 98, and FIG. 99 depict the sectional view 9700, the plan view 9800, and the sectional perspective front view 9900 of the given example depicts the use of the alternative elongated hollow tube 6500, whereas the given example may deposit during the transplanting on a vertical plane as given or, alternatively horizontally, or at any angle keeping at least one end of the air channel 430 open to environmental air movements.

The invention has been described in terms of particular embodiments. The alternatives described herein are examples for illustration only and may not limit the alternatives in any way. Certain steps of the invention may be performed in different shapes and still achieve the desired results. It will be obvious to persons skilled in the art to make various changes and modifications to the invention described herein. To the extent that these variations depart from the scope and spirit of what is described herein, they are intended to be encompassed therein. It will be understood by those skilled in the art that various changes in form and details may be made therein without departing from the scope of the invention encompassed by the appended claims.

What is claimed is:

1. A fertilizer conveyance assembly, comprising:
at least one perforated air cushion;
configured to,
control-release;
at least one fertilizer chemical compound;
for application in the horticultural industry.

2. The fertilizer conveyance assembly of claim 1, comprising:
at least one perforated air cushion;
characterized by,
a plurality of apertures;
with,
a hollow inside;
configured to,
air prune the plant roots;
and,
control-release;
at least one fertilizer chemical compound;
for the application in the horticultural industry.

3. The fertilizer conveyance assembly of claim 1, comprising:
an upper perforated air cushion;
a lower perforated air cushion;
configured to,
air prune the plant roots;
and,
control-release,
the plurality of fertilizer chemical compounds;
characterized by,
the macro and micro required fertilizers,
for application in the horticultural industry.

4. The fertilizer conveyance assembly of claim 1, the perforated air cushion comprising:
a top surface;
and,
a bottom surface;
configured with,
the plurality of apertures on the surfaces;
for the porosity of the air cushion.

5. A fertilizer conveyance device, comprising:
at least one surface;
configured to,
control-release;
at least one fertilizer chemical compound;
for fertilizer conveyance in the horticultural industry.

6. The fertilizer conveyance assembly of claim 1, the perforated air cushion comprising:
a plurality of slot openings;
configured to hold,
a plurality of nutrient bricks;
characterized by,
an appropriate control-release mechanism;
and,
the plurality of fertilizer chemical compounds;
attached to the nutrient brick by any appropriate means;
for the application in the horticultural industry.

7. The fertilizer conveyance assembly of claim 6, the nutrient brick comprising:
the nutrient brick characterized by claim 05;
configured to,
control-release;
at least one fertilizer chemical compound;
for fertilizer conveyance in the horticultural industry.

8. The fertilizer conveyance assembly of claim 1, the perforated air cushion comprising:
at least one slot opening;
configured in;
the mid area;
for,
at least one transplant;
and,
at least one continuous substrate column materialized inside the plant pot to improve the capillary action;
for the application in horticulture.

9. The fertilizer conveyance assembly of claim 1, the perforated air cushion comprising:
a plurality of protrusions;
configured between,
the top surface and the bottom surface;
characterized by,
the plurality of apertures;
with,
the hollow inside;
for the root penetration and air pruning of plant roots.

10. A plant root air pruning device, comprising:
at least one air channel;
characterized by,
a plurality of apertures;
with,
a hollow inside;
configured to,
air prune plant roots;
and,
ventilate the substrate;
for the application in the horticultural industry.

11. The fertilizer conveyance assembly of claim 1 and claim 9, the perforated air cushion comprising:
the plurality of air channels characterized by claim 10;
configured to,
air prune the plant roots;
and,
ventilate the substrate;
for the application in the horticultural industry.

12. The fertilizer conveyance assembly of claim 1, the upper perforated air cushion comprising:
a wing;
configured to,
create an extended empty space under the wing;
to interconnect the air channels.

13. The fertilizer conveyance assembly of claim 1, comprising:
the lower perforated air cushion;
characterized by,
a taller perforated air cushion;
configured to,
create an extended empty space inside;
to materialize,
a water reservoir at the bottom of the plant pot.

14. The fertilizer conveyance assembly of claim 1, the perforated air cushion comprising:
alternatively configured with,
a plurality of perforated layers;
characterized by,
the plurality of apertures;
and,
a plurality of protrusions;
for application in the horticulture industry.

15. The fertilizer conveyance assembly of claim 14, comprising:
at least one perforated air cushion;
alternatively configured with,
the plurality of perforated layers;
characterized by,
the plurality of apertures;
the plurality of protrusions;
with,
a plurality of openings on the protrusions for the root penetration;
configured to,
control-release;
at least one fertilizer chemical compound;
and,
air prune the plant roots;
for application in the horticulture industry.

16. The fertilizer conveyance assembly of claim 14, comprising:
the plurality of perforated layers;
combine together by any appropriate means;
configured to,
form the upper perforated air cushion;
and,
the lower perforated air cushion;
with,
the top perforated layer;
characterized by,
the extended wing;
to materialize,
the extended empty space under the wing;
interconnecting the air channels;
for application in the horticulture industry.

17. The fertilizer conveyance assembly of claim 14, comprising:
the plurality of perforated layers;
configured to,
combine by any appropriate means;
to materialize,
the perforated air cushion;
and,
the plurality of air channels;
characterized by,
stacking of the perforated layers.

18. The fertilizer conveyance assembly of claim 14, the perforated air cushion comprising:
At least one nutrient brick;
configured to hold,
at least one fertilizer chemical compound;
characterized by,
the plurality of different fertilizer supplements;
for the growth of horticultural plants.

19. The fertilizer conveyance assembly of claim 1, comprising:
the upper perforated air cushion;
configured to,
hold Boron (BO₃³⁻) Molybdenum (MoO₄²⁻), Magnesium (Mg²⁺), Iron (Fe²⁺/Fe³⁺), Sulfur (SO₄²⁻);
and,
the lower perforated air cushion;
configured to,
hold Zinc (Zn²⁺), Manganese (Mn²⁺), Copper (Cu⁺/Cu²⁺), Chlorine (Cl⁻), Sulfur (SO₄²⁻), and Calcium (Ca²⁺);
for the improved absorption efficacy.

20. The fertilizer conveyance assembly of claim 1, comprising:
the lower perforated air cushion;
configured to,
deposit at the bottom of a plant pot before filling with the substrate;
and,
fill up the substrate at least up to half of the pot height;
with,
a few inches thick substrate layer on top of the upper perforated air cushion;
materializing,
the water reservoir at the plant pot bottom;
and,
at least one continuous substrate column from bottom to top;
inside the plant pot, for improved absorption efficacy.

21. The fertilizer conveyance device of claim 05, comprising:
any convenient shape;
with,
an extended surface area;
characterized by,
a plurality of apertures;
for the substrate ventilation, and fertilizer delivery.

22. The fertilizer conveyance device of claim 05, comprising:
a hollow core;
with,
the plurality of apertures;
configured to,
hold at least one fertilizer chemical compound;
by,
any appropriate means;
and,
a barrier film;
characterized by,
the control-release chemical compound;
for the control-release of fertilizer chemical compounds embedded within, or
alternatively associated by any appropriate means to the device.

23. The fertilizer conveyance device of claim 05, comprising:
the nutrient brick/platelet;
characterizing,
at least one extended surface area;
configured to,
control-release;
at least one fertilizer chemical compound;
for the application in horticulture.

24. The fertilizer conveyance device claim 05, comprising:
At least two, or more nutrient bricks/nutrient platelets;
configured to,
combine together by any appropriate means;
with/(or alternatively without),
at least one separator;
and,
the control-release barrier film;
as,
a group of multi-nutrient bricks;
characterized by,
a plurality of different fertilizer supplements;
for application in the horticultural industry.

25. The fertilizer conveyance device of claim 05, comprising:
the nutrient brick/the nutrient platelet;
alternatively configured with,
a wing;
for application in the horticultural industry.

26. The plant root air pruning device of claim 10, the air channel comprising:
the hollow inside;
with,
the plurality of apertures;
configured to,
ventilate the substrate;
and,
control-release;
at least one fertilizer chemical compound;
for application in the horticulture industry.

27. The fertilizer conveyance assembly of claim 1, the fertilizer conveyance device claim 05, and the plant root air pruning device of claim 10, comprising:
a permeable layer of biodegradable polymer;
configured to,
enclose the surface;
characterizing,
the control-release of attached fertilizer within the embodiments;
for application in the horticulture industry.

28. The fertilizer conveyance assembly of claim 1, the fertilizer conveyance device claim 05, and the plant root air pruning device of claim 10, comprising:
the perforated air cushion, the nutrient brick, and the air channel;
configured to,
hold fertilizer chemical compounds;
by,
any appropriate means;
and,
a barrier film;
characterized by,
the control-release chemical compound;
for the control-release of the fertilizer chemical compounds embedded within,
or,
alternatively associated by any appropriate means to use in horticulture.

29. The fertilizer conveyance assembly of claim 1, the fertilizer conveyance device claim 05, and the plant root air pruning device of claim 10, comprising:
the specifications of the barrier film;
the release duration of the control-release barrier film;
and,
the individual chemical compound release rates;
configured based on,
the seasonal;
or,
plant-specific nutrient requirements.

30. The fertilizer conveyance assembly of claim 1, the fertilizer conveyance device claim 05, and the plant root air pruning device of claim 10, comprising:
the nutrient bricks;
the air channels;
or,
the perforated air cushions;
configured to alternatively use with,
the commercially available;
pre-made chemical granules;
characterized by,
a fertilizer chemical formula;
a control-release biodegradable coating;
and,
a release duration;
for the application in horticulture.

31. The fertilizer conveyance assembly of claim 14, the fertilizer conveyance device claim 05, and the plant root air pruning device of claim 10, comprising:
At least one separator;
configured to,
distancing the different fertilizer varieties from each other;
and,
reduce unintended chemical interactions;
for the application in horticulture.

32. The fertilizer conveyance assembly of claim 1, the fertilizer conveyance device claim 05, and the plant root air pruning device of claim 10, comprising:
each individual fertilizer chemical compound quantity associated with the embodiment;
configured based on,
the plant-specific nutrient requirements;
or alternatively,
a generic formula;
for application in the horticulture industry.

33. The fertilizer conveyance assembly of claim 1, the fertilizer conveyance device claim 05, and the plant root air pruning device of claim 10, comprising:
the plant absorbable cationic or anionic forms of fertilizers;
characterizing,
Boron (BO₃³⁻), Iron (Fe²⁺/Fe³⁺), Zinc (Zn²⁺), Manganese (Mn²⁺), Copper (Cu⁺/Cu²⁺), Chlorine (Cl⁻), Molybdenum (MoO₄²⁻), Nickel (Ni²⁺), Sulfur (SO₄²⁻), Magnesium (Mg²⁺), Calcium (Ca²⁺), and Cobalt (Co²⁺);
configured to,
attach to the embodiment by any appropriate means;
for the application in horticulture.

34. The fertilizer conveyance assembly of claim 1, the fertilizer conveyance device claim 05, and the plant root air pruning device of claim 10, comprising:
any biodegradable material;
including but not limited to,
recycled kraft paper, or paper board for sustainability;
or,
wood chips, sawdust, compost, fiber;
or,
any appropriate material alternatively be substituted as appropriate;
with,
any suitable commercially available,
buffers;
binders;
and,
appropriate control-release chemical compounds.

35. The fertilizer conveyance assembly of claim 1, the fertilizer conveyance device claim 05, and the plant root air pruning device of claim 10, comprising:
alternatively, or in addition,
the plurality of nutrient bricks;
the plurality of nutrient platelets;
and,
the plurality of air channels;
may deposit in the horizontal plane;
or,
vertical plane;
or,
in a downward spiral;
inside a plant pot, or in a field;
with, or without any attachments;
as an independent plant nutrient treatment.

36. A plant root air pruning device, comprising:
at least one perforated air cushion;
configured to,
air prune the plant roots;
for application in the horticultural industry.

37. The plant root air pruning device of claim 36, plant root air pruning device comprising:
any of the claims 2 to 35 as appropriate and applicable.
